(19) United States
(12) Patent Application Publication
(10) Pub. No.: US 2023/0094355 A1
(43) Pub. Date: Mar. 30, 2023

(54) SYSTEM AND METHOD FOR ENFORCING MONOTONICITY IN A NEURAL NETWORK ARCHITECTURE

(71) Applicant: ROYAL BANK OF CANADA, Toronto (CA)

(72) Inventors: Joao Batista Monteiro FILHO, Montreal (CA); Mohamed Osama AHMED, Vancouver (CA); Seyed Hossein HAJIMIRSADEGHI, Vancouver (CA); Gregory Peter MORI, Burnaby (CA)

(21) Appl. No.: 17/943,958

(22) Filed: Sep. 13, 2022

Related U.S. Application Data
(60) Provisional application No. 63/243,925, filed on Sep. 14, 2021.

(51) Int. Cl. G06N 3/08

(52) U.S. Cl. CPC G06N 3/08

(57) ABSTRACT

A computer-implemented system and method for training a neural network with enforced monotonicity are disclosed. An example system includes at least one processor and memory in communication with said at least one processor, wherein the memory stores instructions for providing a data model representing a neural network for predicting an outcome based on input data, the instructions when executed at said at least one processor causes said system to: receive a feature data as input data; predict an outcome based on the input data using the neural network; compute a loss function based on the predicted outcome and an expected outcome associated with the input data, the loss function [symbol] being dependent on a monotonicity penalty Ω computed based on a set of training data including the feature data and on a set of random data; and update weights of the neural network based on the loss function.

### CROSS-REFERENCE TO RELATED APPLICATION

This application claims the benefit of and priority to U.S. provisional patent application No. 63/243,925, filed on Sep. 14, 2021, the entire content of which is herein incorporated by reference.

### FIELD

The present disclosure generally relates to the field of computer processing and neural network systems. More specifically, the disclosure relates to training of neural network systems.

### BACKGROUND

Artificial neural networks, trained under the empirical risk minimization framework, have achieved certain prediction performance across a broad range of supervised learning tasks and domains such as object recognition, speech recognition, machine translation, among many other examples. However, finding predictors attaining low risk on unseen data is often not sufficient to enable the use of such models in practice.

### SUMMARY

According to an aspect, there is provided a computer-implemented system for training a neural network with enforced monotonicity. The system includes at least one processor and memory in communication with said at least one processor, wherein the memory stores instructions for providing a data model representing a neural network for predicting an outcome based on input data, the instructions when executed at said at least one processor causes said system to: receive a feature data as input data; predict an outcome based on the input data using the neural network; compute a loss function based on the predicted outcome and an expected outcome associated with the input data, the loss function [symbol] being dependent on a monotonicity penalty Ω computed based on a set of training data including the feature data and on a set of random data; and update weights of the neural network based on the loss function.

In some embodiments, the feature data comprises monotonic feature data.

In some embodiments, the feature data comprises non-monotonic feature data.

In some embodiments, the set of random data excludes the training data.

In some embodiments, the monotonicity penalty Ω is determined based on interpolation of the training data and extrapolation of the training data and the random data.

In some embodiments, interpolation of the training data comprises mixing up data points from the training data.

In some embodiments, interpolation of a pair of data points (x′, y′), (x″, y″) from the training data comprises generating new data points for training based on (λx′+(1−λ)x″, λy′+(1−λ)y″), and λ˜Uniform([0,1]).

In some embodiments, the monotonicity penalty D. is determined based on at least one of: interpolation of the training data, extrapolation of the training data, interpolation of the training data and the random data, and extrapolation of the training data and the random data.

In some embodiments, interpolation of a pair of data points (x′, y′) from training data and (x″, y″) from the random data comprises generating new data points for training based on (λx′+(1−λ)x″, λy′+(1−λ)y″), and λ˜Uniform([0,1]). where x′ comprises feature data and y′ comprises the expected outcome.

In some embodiments, extrapolation of the training data and the random data comprises mixing up data points from the training data and the random data.

In some embodiments, extrapolation of the training data and the random data comprises generating new data points for training by, for each batch of training data with size N>1: augmenting the batch of training data with data points from the random data to obtain a new batch of mixed up training data of size 2N; and out of

$$\frac{2 N ( 2 N - 1 )}{2}$$

possible pairs of data points from the new batch of mixed up training data, selecting a random sample of k pairs of data points, wherein for each pair of data points (xm′, ym′), (xm″, ym″) from the k pairs: generating new data points for training based on (λxm′+(1−λ)xm″, λym′+(1−λ)ym″), wherein λ˜Uniform([0,1]), and λ is independently drawn.

In some embodiments, a monotonic predictor is represented by

$${h}_{M}^{*} ∈ arg {min}_{h ∈ ℋ} {𝔼}_{x ∼ 𝒳} [ ( h ( x ) , y ) ] + γ Ω ( h , M ) ,$$

and Ω(h, M) is the monotonicity penalty configured to measure the monotonicity of the monotonic predictor h⁺_{M} relative to input dimensions indicated by M, M⊂{1, . . . d} being indicative of a subset of the input dimensions and including at least some of the monotonic feature data from the input data.

In some embodiments,

$$Ω ( h , M ) = {𝔼}_{x ∼ 𝒟} [ {\sum }_{i ∈ M} max {( 0 , - \frac{\partial h ( x )}{\partial {x}_{i}} )}^{2} ] ,$$

$$wherein \frac{\partial h ( x )}{\partial {x}_{i}}$$

indicates the gradients of h⁺_{M} relative to the input dimensions i∈M.

In some embodiments, [symbol] comprises data points generated by the interpolation of the training data and by the extrapolation of the training data and the random data.

According to another aspect, there is provided a computer-implemented method for training a neural network with enforced monotonicity, the method including: accessing a data model representing a neural network for predicting an outcome based on input data; receiving a feature data as input data; predicting an outcome based on the input data using the neural network; computing a loss function based on the predicted outcome and an expected outcome associated with the input data, the loss function [symbol] being dependent on a monotonicity penalty Ω computed based on a set of training data including the feature data and on a set of random data; and updating weights of the neural network based on the loss function.

In some embodiments, the feature data comprises monotonic feature data.

In some embodiments, the feature data comprises non-monotonic feature data.

In some embodiments, the set of random data excludes the training data.

In some embodiments, the monotonicity penalty D. is determined based on interpolation of the training data and extrapolation of the training data and the random data.

In some embodiments, interpolation of the training data comprises mixing up data points from the training data.

In some embodiments, interpolation of a pair of data points (x′, y′), (x″, y″) from the training data comprises generating new data points for training based on (λx′+(1−λ)x″, λy′+(1−λ)y″), and λ˜Uniform([0,1]).

In some embodiments, the monotonicity penalty D. is determined based on at least one of: interpolation of the training data, extrapolation of the training data, interpolation of the training data and the random data, and extrapolation of the training data and the random data.

In some embodiments, interpolation of a pair of data points (x′, y′) from training data and (x″, y″) from the random data comprises generating new data points for training based on (λx′+(1−λ)x″, λy′+(1−λ)y″), and λ˜Uniform([0,1]), where x′ comprises feature data and y′ comprises the expected outcome.

In some embodiments, extrapolation of the training data and the random data comprises mixing up data points from the training data and the random data.

In some embodiments, extrapolation of the training data and the random data comprises generating new data points for training by, for each batch of training data with size N>1: augmenting the batch of training data with data points from the random data to obtain a new batch of mixed up training data of size 2N; and out of

$$\frac{2 N ( 2 N - 1 )}{2}$$

possible pairs of data points from the new batch of mixed up training data, selecting a random sample of k pairs of data points, wherein for each pair of data points (xm′, ym′), (xm″, ym″) from the k pairs: generating new data points for training based on (λxm′+(1−λ)xm″, λym′+(1−λ)ym″), wherein λ˜Uniform([0,1]), and λ is independently drawn.

In some embodiments, a monotonic predictor is represented by

$${h}_{M}^{*} ∈ arg {min}_{h ∈ ℋ} {𝔼}_{x ∼ 𝒳} [ ( h ( x ) , y ) ] + γ Ω ( h , M ) ,$$

and Ω(h, M) is the monotonicity penalty configured to measure the monotonicity of the monotonic predictor h*_{M} relative to input dimensions indicated by M, M⊂{1, . . . d} being indicative of some subset of the input dimensions and including at least some of the monotonic feature data from the input data.

In some embodiments,

$$Ω ( h , M ) = {𝔼}_{x ∼ 𝒟} [ {\sum }_{i ∈ M} max {( 0 , - \frac{\partial h ( x )}{\partial {x}_{i}} )}^{2} ] ,$$

$$wherein \frac{\partial h ( x )}{\partial {x}_{i}}$$

indicates the gradients of h*_{M} relative to the input dimensions i∈M.

In some embodiments, [symbol] comprises data points generated by the interpolation of the training data and by the extrapolation of the training data and the random data.

In accordance with yet another aspect, there is provided a non-transitory computer-readable storage medium storing storing a data model representing a neural network for predicting an outcome based on input data, wherein the neural network is trained by: receiving a feature data as input data; predicting an outcome based on the input data using the neural network; computing a loss function based on the predicted outcome and an expected outcome associated with the input data, the loss function [symbol] being dependent on a monotonicity penalty Ω computed based on a set of training data including the feature data and on a set of random data; and updating weights of the neural network based on the loss function.

In some embodiments, the feature data comprises monotonic feature data.

In some embodiments, the set of random data excludes the training data.

In some embodiments, the monotonicity penalty Ω is determined based on interpolation of the training data and extrapolation of the training data and the random data.

In some embodiments, interpolation of the training data comprises mixing up data points from the training data.

In some embodiments, interpolation of a pair of data points (x′, y′), (x″, y″) from the training data comprises generating new data points for training based on (λx′+(1−λ)x″, λy′+(1−λ)y″), and λ˜Uniform([0,1]).

In some embodiments, extrapolation of the training data and the random data comprises mixing up data points from the training data and the random data.

In some embodiments, extrapolation of the training data and the random data comprises generating new data points for training by, for each batch of training data with size N>1: augmenting the batch of training data with data points from the random data to obtain a new batch of mixed up training data of size 2N; and out of

$$\frac{2 N ( 2 N - 1 )}{2}$$

possible pairs of data points from the new batch of mixed up training data, selecting a random sample of k pairs of data points, wherein for each pair of data points (xm′, ym′), (xm″, ym″) from the k pairs: generating new data points for training based on (λxm′+(1−λ)xm″, λym′+(1−λ)ym″), wherein λ˜Uniform([0,1]), and λ is independently drawn.

In some embodiments, a monotonic predictor is represented by

$${h}_{M}^{*} ∈ arg {min}_{h ∈ ℋ} {𝔼}_{x ∼ 𝒳} [ ( h ( x ) , y ) ] + γ Ω ( h , M ) ,$$

and Ω(h, M) is the monotonicity penalty configured to measure the monotonicity of the monotonic predictor h*_{M} relative to input dimensions indicated by M, M⊂{1, . . . d} being indicative of a subset of the input dimensions and including at least some of the monotonic feature data from the input data.

In some embodiments,

$$Ω ( h , M ) = {𝔼}_{x ∼ 𝒟} [ {\sum }_{i ∈ M} {max ( 0 , - \frac{\partial h ( x )}{\partial {x}_{i}} )}^{2} ] , wherein \frac{\partial h ( x )}{\partial {x}_{i}}$$

indicates the gradients of h*_{M} relative to the input dimensions i∈M.

In some embodiments, [symbol] comprises data points generated by the interpolation of the training data and by the extrapolation of the training data and the random data.

Other features will become apparent from the drawings in conjunction with the following description.

### BRIEF DESCRIPTION OF DRAWINGS

In the figures which illustrate example embodiments,

FIG. 1 is an example schematic diagram of a training system, in accordance with an embodiment.

FIG. 2 is a schematic diagram of an example neural network maintained at the computer-implemented system of FIG. 1.

FIG. 3 is a schematic diagram of a computing device that implements a training system, in accordance with an embodiment.

FIG. 4 shows an example process performed the training system in FIG. 1, in accordance with an embodiment.

FIGS. 5A and 5B show comparisons between data generated by standard and monotonic models, in accordance with an embodiment.

FIG. 6 shows a group monotonic convolutional model splitting representations into disjoint subsets, in accordance with an embodiment.

FIG. 7 shows an example n-sphere, in accordance with an embodiment.

FIGS. 8A and 8B illustrate uniformly distributed draws on a unit sphere in concentrate on its boundary for large n, in accordance with an embodiment.

### DETAILED DESCRIPTION

Highly expressive model classes such as artificial neural networks have achieved impressive prediction performance across a broad range of supervised learning tasks and domains such as object recognition, speech recognition, machine translation, among many other examples. However, finding predictors attaining low risk on unseen data is often not enough to enable the use of such models in practice. Practical applications usually have more requirements beside the prediction accuracy. Hence, devising approaches that search risk minimizers satisfying practical needs led to development of neural networks in real-life scenarios. Examples of such requirements include robustness, fairness, explainability (or interpretability), and monotonicity.

Robustness means low risk is expected even if the neural network model is evaluated under distribution shifts or adversarial perturbations. Fairness means the performance of the neural network model is expected to not significantly change across different sub-populations of the data. Explainability or interpretability means neural network models are expected to indicate how the features of the data affect the predictions of the model.

Disclosed herein are systems and methods for enforcing monotonicity in neural networks with respect to a given subset of the dimensions of the input space. The disclosed systems and method focus on the setting where point-wise gradient penalties (“monotonicity penalty”) are used as a soft constraint alongside the empirical risk during training. Experimental results indicate that the choice of the points employed for computing a monotonicity penalty defines the regions of the input space where the desired property is satisfied.

In addition to the requirements mentioned above, a property commonly expected in trained models in certain applications is monotonicity with respect to a subset of the input dimension or input data. For example, monotonicity means that an increase (or decrease) along some particular dimensions of the input data strictly imply the function value will not decrease (or will not increase), provided that all other dimensions are kept fixed. As a result, the behavior of monotonic models tend to be aligned with properties that the data under consideration is believed to satisfy. For example, in the case of a neural network model used to screen job applications, it may be expected that evaluation of the job applications (e.g., a score) to be monotonically non-decreasing with respect to features such as past years of experience of a candidate. Thus, given two candidates, A and B, all else being equal, if A has more years of professional experience, then A is expected to have higher, or at least the same, chance of getting accepted as B.

Similar observations can be made when applying neural network models to other fields. For another example, given two loan applicants, C and D, all else being equal, if C has a higher credit score, then C is expected to have higher, or at least the same, chance of getting the loan as D.

For yet another example, in medical applications, given two different x-ray images for patients E and F, all else being equal, if E has a longer history of smoking, then E is expected to have higher, or at least the same, chance of being diagnosed with lung cancer. For applications where monotonicity of a neural network model is expected, models failing to satisfy this requirement would damage the users' confidence.

Given the importance of enforcing monotonicity properties in numerous applications, different strategies have been devised in order to enable learning of monotonic predictors. These approaches can be divided into two main categories: 1) monotonicity by construction and 2) enforcing monotonicity during model training.

Monotonicity by construction focuses on defining a model class that guarantees monotonicity in all of its elements. However, this approach can not be used with general architectures in the case of neural networks. Additionally, the model class might be so constrained that it might affect the prediction performance.

Enforcing or encouraging monotonicity during model training searches for monotonic candidates within a general class of models. Such group of methods is more generally applicable and can be used, for instance, with any neural network architecture. However, they are not guaranteed to yield monotonic predictors unless the monotonicity of the trained model is verified, which can be computationally expensive. Moreover, several retraining cycles might be required to enforce monotonicity.

In order to enforce or encourage monotonicity during training of a neural network model, a loss function may be used to fine tune the weights of the neural network model, where the loss function, which may be represented by [symbol] , is computed based on a monotonicity penalty Ω, as further described in detail below. The calculation of the monotonicity penalty Ω can be dependent on a set of sample or data distribution [symbol] . In one case, when the data points in [symbol] used to calculate the monotonicity penalty Ω are limited to training samples, the resulting trained neural network model tends to only enforce monotonicity in the region where the training samples lie. In this case, the the data points in [symbol] used to calculate the monotonicity penalty Ω are too localized on training samples or training data.

In another case, when the data points in [symbol] used to calculate the monotonicity penalty Ω are defined to include random data drawn uniformly across an entire input space, the resulting trained neural network model tends to only enforce monotonicity at the boundaries of the space. That is, the data points in [symbol] used to compute the monotonicity penalty Ω are too far away from the training samples or training data.

While previous methods result in neural network models that are monotonic either only at the boundaries of the input space or in the small volume where training data lie, the disclosed systems and methods use pairs of training data and random points to generate mixtures of data points that lie inside and outside of the convex hull of a given training sample. Empirical evaluation carried out using different datasets show that the disclosed systems and method yield predictors that are monotonic in a larger volume of the space compared to previous methods. Moreover, the disclosed systems and method do not introduce computational overhead, leading to an efficient procedure that consistently achieves monotonicity in trained neural networks.

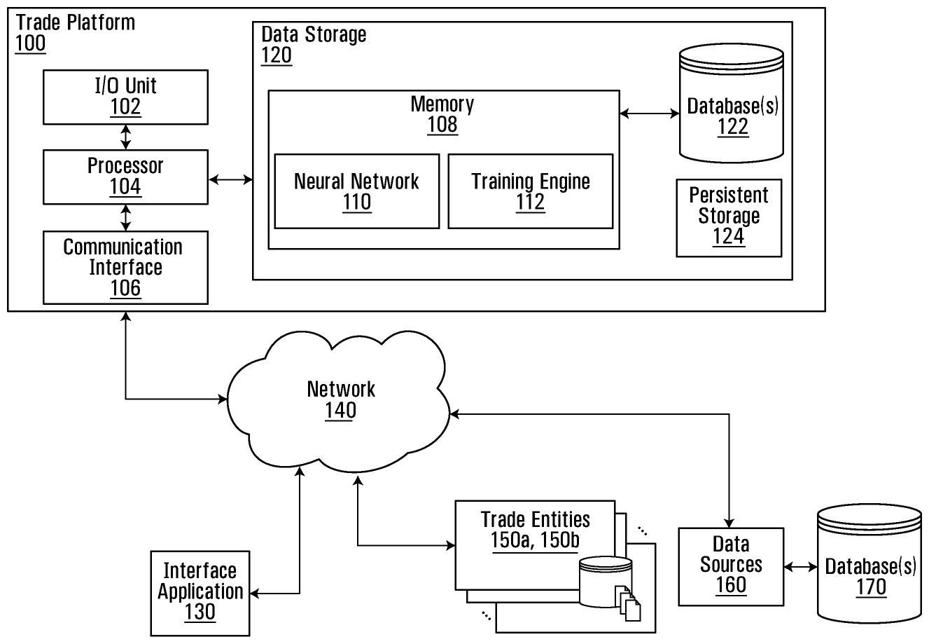

A general computer system is described next in which the various neural network models may be implemented for training. FIG. 1 is a high-level schematic diagram of an example computer-implemented system 100 for training a neural network 110, exemplary of embodiments. For example, automated agents can be instantiated and trained by training engine 112, where each automated agent maintains and updates a respective neural network 110.

As detailed herein, in some embodiments, system 100 includes features adapting it to perform certain specialized purposes, e.g., as a training platform to train a neural network 110 to generate predictions based on a given set of feature data. In such embodiments, system 100 may be referred to as platform 100 for convenience.

Referring now to the embodiment depicted in FIG. 1, platform 100 can include an I/O unit 102, a processor 104, communication interface 106, and data storage 120. The I/O unit 102 can enable the platform 100 to interconnect with one or more input devices, such as a keyboard, mouse, camera, touch screen and a microphone, and/or with one or more output devices such as a display screen and a speaker.

A processor 104 is configured to execute machine-executable instructions to train a neural network 110 through a training engine 112. The training engine 112 can be configured to generate signals based on one or more rewards or incentives to train the neural network 110 to perform desired tasks more optimally, e.g., to minimize and maximize certain performance metrics such as minimizing risk or a loss function. For example, the training engine 112 may be configured to perform and execute standard supervised learning, where data instances are observed in pairs x, y·⊂× [symbol] , and χ⊂ [symbol] ^{d} and [symbol] [symbol] ⊂ [symbol] correspond to the input and output spaces, respectively.

Given the standard supervised learning setting, [symbol] : [symbol] ² [symbol] ⁺ is a loss function indicating the goodness of the predictions relative to ground truth targets, the goal for the training engine 112 is to find a predictor h∈ [symbol] such that its expected loss, or the risk, over the input space is minimized. Such an approach yields the empirical risk minimization framework once a finite sample is used to estimate the risk.

The platform 100 can connect to an interface application 130 installed on user device to receive input data. Trade entities 150a, 150b can interact with the platform to receive output data and provide input data. The trade entities 150a, 150b can have at least one computing device. The platform 100 can train one or more neural networks 110. The trained neural networks 110 can be used by platform 100 or can be for transmission to trade entities 150a, 150b, in some embodiments. The platform 100 can process trade orders using the neural network 110 in response to commands from trade entities 150a, 150b, in some embodiments.

The platform 100 can connect to different data sources 160 and databases 170 to receive input data and receive output data for storage. The input data can include feature data. Network 140 (or multiple networks) is capable of carrying data and can involve wired connections, wireless connections, or a combination thereof. Network 140 may involve different network communication technologies, standards and protocols, for example.

The processor 104 can execute instructions in memory 108 to implement aspects of processes described herein. The processor 104 can execute instructions in memory 108 to configure a data collection unit, interface unit (to provide control commands to interface application 130), neural network 110, training engine 112, and other functions described herein. The processor 104 can be, for example, any type of general-purpose microprocessor or microcontroller, a digital signal processing (DSP) processor, an integrated circuit, a field programmable gate array (FPGA), a reconfigurable processor, or any combination thereof.

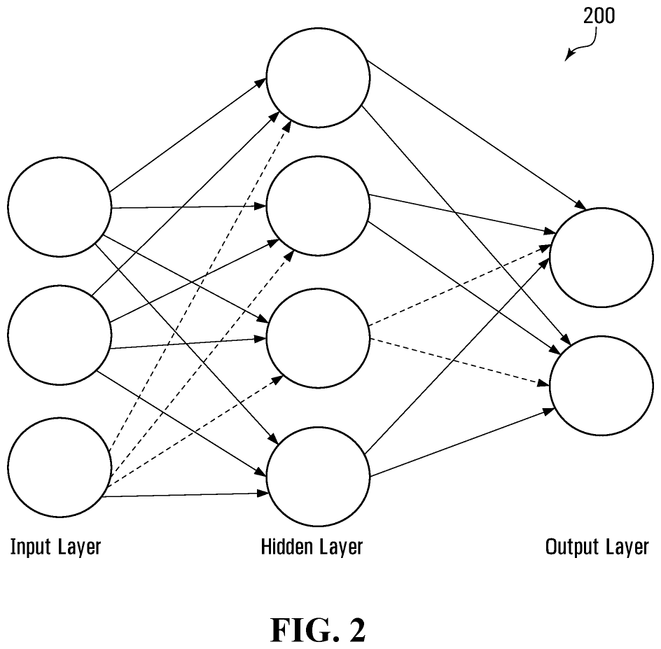

FIG. 2 is a schematic diagram of an example neural network 200 according to some embodiments. The example neural network 200 can include an input layer, a hidden layer, and an output layer. The neural network 200 processes input data using its layers based on weights, for example.

Referring again to FIG. 1, the interface application 130 interacts with the platform 100 to exchange data (including control commands) and generates visual elements for display at user device. The visual elements can represent neural networks 110 and output generated by neural networks 110.

Memory 108 may include a suitable combination of any type of computer memory that is located either internally or externally such as, for example, random-access memory (RAM), read-only memory (ROM), compact disc read-only memory (CDROM), electro-optical memory, magneto-optical memory, erasable programmable read-only memory (EPROM), and electrically-erasable programmable read-only memory (EEPROM), Ferroelectric RAM (FRAM) or the like. Data storage devices 120 can include memory 108, databases 122, and persistent storage 124.

The communication interface 106 can enable the platform 100 to communicate with other components, to exchange data with other components, to access and connect to network resources, to serve applications, and perform other computing applications by connecting to a network (or multiple networks) capable of carrying data including the Internet, Ethernet, plain old telephone service (POTS) line, public switch telephone network (PSTN), integrated services digital network (ISDN), digital subscriber line (DSL), coaxial cable, fiber optics, satellite, mobile, wireless (e.g. Wi-Fi, WiMAX), SS7 signaling network, fixed line, local area network, wide area network, and others, including any combination of these.

The platform 100 can be operable to register and authenticate users (using a login, unique identifier, and password for example) prior to providing access to applications, a local network, network resources, other networks and network security devices. The platform 100 may serve multiple users which may operate trade entities 150a, 150b.

The data storage 120 may be configured to store information associated with or created by the components in memory 108 and may also include machine executable instructions. The data storage 120 includes a persistent storage 124 which may involve various types of storage technologies, such as solid state drives, hard disk drives, flash memory, and may be stored in various formats, such as relational databases, non-relational databases, flat files, spreadsheets, extended markup files, etc.

The disclosed systems and methods, such as system 100, is configured to perform empirical risk minimization in large classes of neural network models, while simultaneously searching for monotonic predictors within the set of risk minimizing solutions.

As will be evident further below, previous methods can only satisfy monotonicity either near the training data or near the boundaries of the input domain. The disclosed systems and methods, however, carefully select and mix data points used in calculating the monotonicity constraint, which is a more efficient algorithm. The disclosed systems and methods, given the same budget, can enforce monotonicity in a bigger volume of the input space compared to the previous methods in literature.

### Practical Applications of Monotonicity Enforced Neural Network

During training of monotonicity enforced neural network, monotonic features are labelled, and the input data comprises monotonic feature data. Each neural network is trained specifically for an application.

In some example embodiments, a trained monotonicity enforced neural network is implemented to assist with automatic resume screening. Each resume may be processed to extract one or more feature data such as: education, experiences, and interests, among which experience may be a monotonic feature data. The trained monotonicity enforced neural network is configured to take a number of different resumes from different candidates, and predict a probability of an offer for each candidate based on the corresponding resume, where a candidate with a greater amount of experience for the job posting is guaranteed to receive a higher probability or higher score of offer than another candidate who has a less experience, assuming all other relevant feature data (e.g., education) for both candidates are the same.

Alternatively, using a different trained monotonicity enforced neural network, education may be designed as a monotonic feature data as part of input to the neural network. In this case, the trained monotonicity enforced neural network is configured to take a number of different resumes from different candidates, and predict a probability of an offer for each candidate based on the corresponding resume, where a candidate with a higher education level for the job posting is guaranteed to receive a higher probability or higher score of offer than another candidate who has a lower education level, assuming all other relevant feature data (e.g., experiences) for both candidates are the same.

In some example embodiments, a trained monotonicity enforced neural network is implemented to assist with property vaulation. Each data set corresponding to a property (e.g., a house or an apartment) may be processed to extract one or more feature data such as: square footage, age, address, type of property, historical sales, among which square footage may be a monotonic feature data. The trained monotonicity enforced neural network is configured to take a number of different data sets corresponding to different properties, and predict a valuation score for each property based on the corresponding data set, where a property with a greater amount of square footage is guaranteed to receive a higher valuation score than another property that has less square footage, assuming all other relevant feature data (e.g., age, neighbourhood, type of property) for both properties are the same.

In some example embodiments, a trained monotonicity enforced neural network is implemented to assist with prediction of tumour in based on medical images and historical health data of different patients. Each data set corresponding to a patient may be processed to extract one or more feature data such as: medical images (e.g., x-ray, MRI), age, gender, a total number of medical visits, among which age may be a monotonic feature data. The trained monotonicity enforced neural network is configured to take a number of different data sets corresponding to different patients, and predict a tumour diagnosis score for each patient based on the corresponding data set, where an older patient is guaranteed to receive a higher tumour diagnosis score indicative of a higher probability of a tumour diagonsis, than a younger patient, assuming all other relevant feature data (e.g., medical images, gender, a total number of medical visits) for both patients are the same.

To better explain the disclosed systems and method, the notion of partial monotonicity is herein defined. In a standard supervised learning setting, data instances are observed in pairs z, y˜χ× [symbol] , where χ⊂ [symbol] ^{d} and [symbol] ⊂ [symbol] correspond to the input and output spaces, respectively. The neural network 110 can be represented by a function f: χ [symbol] , and let M indicate some subset of the input dimensions, i.e. M⊂{1, . . . d}, such that x=concat(x_{M}, x_{M̅}), where M={1, . . . , d}\M. Function calls to f can be written as f(x)=f(xₘ,x_{M̅}).

M⊂{1, . . . d} may include at least some of the monotonic feature data from the input data.

### Definitions

Partially monotonic functions relative to M: f is monotonically non-decreasing relative to M, denoted f_{M}, if f(x_{M}, x_{M})≤f(x′_{M}, x_{M̅}), ∀x_{M}≤x′_{M}, ∀x_{M̅}, where the comparison x_{M}≤x′_{M} is performed for every dimension. Monotonically non-increasing f can be defined analogously.

The above definition covers functions that do not decrease in value given increasing changes along a subset of the input dimensions, provided that all other dimensions are kept unchanged.

Several approaches exist for defining model classes that have such property. The simplest approach restricts the weights of the network to be non-negative. However, doing so affects the prediction performance. Another approach corresponds to using the lattice regression models. In such case, models are given by interpolations in a grid defined by training data. While such class of models can be made monotonic via the choice of the interpolation strategy, it scales poorly with the dimension of the input space, but downstream applications might still require different classes of models to satisfy this type of property.

For neural networks, some approaches reparameterize fully connected layers such that gradients with respect to parameters can only be non-negative. On the other hand, in some other approaches, a class of predictors H: χ [symbol] of the form H(x)=∫₀^{x}h(t)dt+H(0) is defined, where h(t) is parameterized by a neural network. Given that h(t) is strictly positive, which can be easily enforced via the choice of the activation function, the resulting H(x) will be montonically non-decreasing. While such approaches guarantee monotonicity by design, they can be too restrictive or render overly complicated learning procedures. For example, some approach requires performing backpropagation through the integration operator.

An alternative approach to that of constraining the model class is to search over general classes of models while assigning higher importance to candidate predictors that are observed to be monotonic in certain parts of the space. Similar to the case of adversarial training, an approach finds counterexamples, i.e., pair of points where the monotonicity constraint is violated. The counter examples are then included in the training data with adjustments to their target values so as to enforce next iterates of the model will satisfy the monotonicity conditions for them. However, this approach only supports fully-connected ReLU networks. Moreover, the procedure for finding the counterexamples is costly. Alternatively, a regularization penalty is introduced in so that monotonicity is point-wise enforced during training. This requires selecting the points where the penalty is computed during training. Some methods use random draws from a uniform distribution over χ, such as applying the regularization penalty over the training instances only. As will be further discussed, both approaches have shortcomings that can be addressed by the disclosed systems and methods described next.

In some embodiments, given the standard supervised learning setting where [symbol] : [symbol] ² [symbol] ⁺ is a loss function indicating the goodness of the predictions relative to ground truth targets, the goal of the training engine 112 is to find a predictor h∈ [symbol] such that its expected loss—or the so-called risk—over the input space is minimized. Such an approach yields the empirical risk minimization framework once a finite sample is used to estimate the risk. However, given the extra monotonicity requirement, the disclosed system 100 is configured to implement an augmented framework where such property is further enforced. For example, the training engine 112 is configured to seek the optimal monotonic predictors relative to M—denoted h*_{M}—such that:

$${h}_{M}^{*} ∈ {argmin}_{h ∈ ℋ} {𝔼}_{x , y ∼ 𝒳 \times 𝒴} [ ℓ ( h ( x ) , y ) ] + γ Ω ( h , M ) , \qquad ( 1 )$$

where γ is a hyperparameter weighing the importance of the monotonicity penalty Ω(h, M) which, in turn, is a measure of how monotonic the predictor h is relative to the dimensions indicated by M. The monotonicity penalty Ω(h, M) can be defined by the following gradient penalty:

$$Ω ( h , M ) = {𝔼}_{x ∼ 𝒟} [ {\sum }_{i ∈ M} max {( 0 , - \frac{\partial h ( x )}{\partial {x}_{i}} )}^{2} ] . \qquad ( 2 )$$

where

$$\frac{\partial h ( x )}{\partial {x}_{i}}$$

indicates the gradients of h relative to the input dimensions i∈M, which are constrained to be non-negative, rendering h monotonically non-decreasing relative to M.

At this point, in order to define a practical algorithm to estimate h*_{M} in Eq. (1), the distribution [symbol] over which the expectation in Eq. 2 is computed needs to be defined. In the next paragraphs, the choices of [symbol] in prior work and the consequential issues of such choices are first discussed, then the disclosed embodiments of system 100 are described to address those issues.

1. Define [symbol] as the empirical distribution of the training samples: given a training dataset of size n, in addition to using the observed data to estimate the risk, the same data is used to compute the monotonicity penalty so that:

$${Ω}_{train} ( h , M ) = \frac{1}{N} {\sum }_{k = 1}^{N} {\sum }_{i ∈ M} {max ( 0 , - \frac{\partial h ( {x}^{k} )}{\partial {x}_{i}^{k}} )}^{2} ,$$

where x^{k} indicates the k-th instance within the training sample. While this choice seems natural and can be easily implemented, it only enforces monotonicity in the region where the training samples lie, which can be problematic. For example, in case of covariate-shift, the test data might lie in parts of the space different from that of the training data so monotonicity cannot be guaranteed. In this case, the data points used to define [symbol] are too localized on training data. The monotonicity property needs to be enforced in a region larger than what is defined by the training data.

2. Define [symbol] =Uniform(χ): a simple strategy is defined so that Ω is computed over the random points drawn uniformly across the entire input space χ; i.e.:

$${Ω}_{r a n d o m} ( h , M ) = x ∼ U ( 𝒳 ) [ {\sum }_{i ∈ M} {max ( 0 , - \frac{\partial h ( x )}{\partial {x}_{i}} )}^{2} ] .$$

Despite its simplicity and ease of use, the approach above still has flaws. In high-dimensional spaces, random draws from any distribution of bounded variance will likely lie in the boundaries of the space, hence far from the regions where data actually lie. Moreover, it is commonly observed that naturally occurring high-dimensional data is structured in lower-dimensional manifolds. It is thus likely that random draws will lie nowhere near regions of space where training/testing data will be observed.

For example, consider the cases of uniform distributions over the unit n-sphere. In such a case, the probability of a random draw lying closer to the sphere's surface than to its center is

$$P ( {‖ x ‖}_{2} > \frac{1}{2} ) = \frac{{2}^{n} - 1}{{2}^{n}} ,$$

as given by the volume ratio of the two regions of interest. Note that P(∥x∥₂>½)→1 and n→∞, which suggests some approach will only enforce monotonicity at the boundaries of the space. That is, the data points used to define D are too far away from the training data.

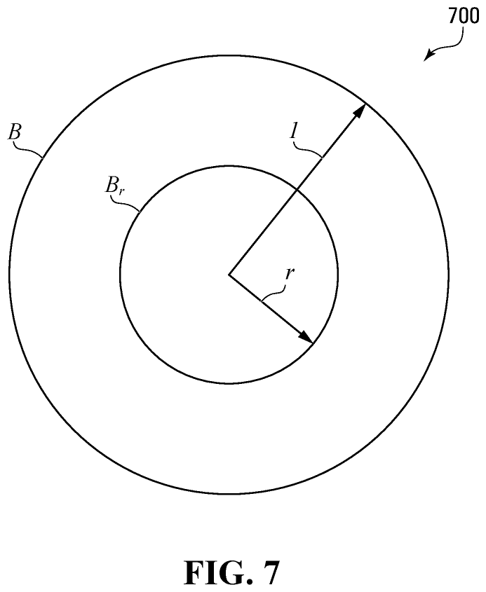

Illustrated in FIG. 7 is a simple example considering random draws from the unit n-sphere 700, i.e., the set of points B={x∈ [symbol] ⁿ: ∥x∥₂<1}. Further consider a concentric sphere of radius 0<r<1 given by Br={x∈ [symbol] ⁿ: ∥x∥₂<r}, it is desired to compute the probability of a random draw from B to lie outside of Br, i.e.: P(∥x∥₂>r), x˜ [symbol] ( [symbol] ), for some distribution D. Start by defining D as the Uniform(B), which results in P(∥x∥₂>r)=(1−rⁿ).

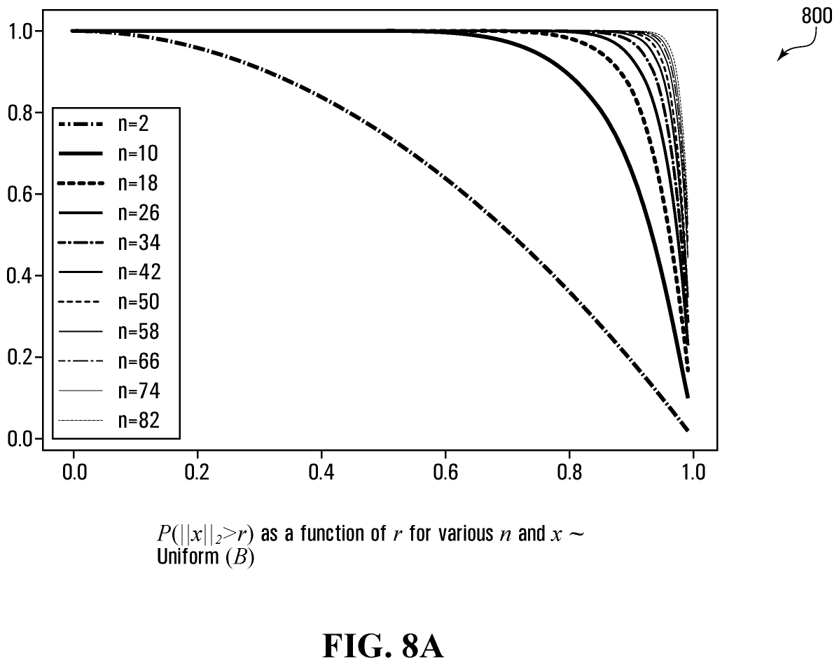

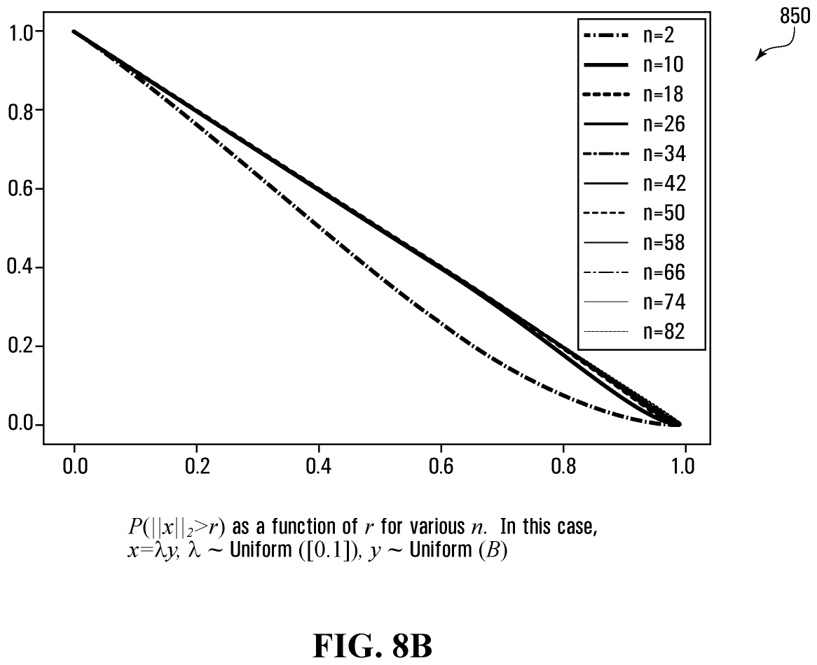

FIGS. 8A and 8B illustrate example showing that uniformly distributed draws on a unit sphere [symbol] ⁿ in concentrate on its boundary for large n. Applying mixup populates the interior of the space. In FIG. 8A, graph 800 shows that for growing n, P(∥x∥₂>r) is very large even if r≈1, which suggests most random draws will lie close to B's boundary.

Now evaluate the case where mixup is applied and random draws are taken in two steps: first observe y˜Uniform(B), and then perform mixup between y and the origin, i.e., x=λy, λ˜Uniform([0,1]). In this case, P(∥x∥₂>r)=(1−rⁿ)(1−r), which is shown in graph 850 in FIG. 8B as a function of r for increasing n. It can be then observed that even for large n, P(∥x∥₂>r) decays linearly with r, i.e., the interior of B and x in this case follows a non-uniform distribution such that its norms histogram is uniform.

In summary, the previous approaches in the industry are either too focused in enforcing monotonicity where the training data lie, or too loose such that the monotonicity property is uniformly enforced across a large space, and the actual data manifold may be neglected. In comparison, the disclosed systems and methods can be configured to select data points for [symbol] with better control over the volume of the input space where the monotonicity property will be enforced. In some embodiments, the system 100 may generate mixed up data points for training, where additional, auxiliary data is generated via interpolations of pairs of data points.

Mixup of data points has the goal of training classifiers for which the outputs are smooth across trajectories in the input space from instances of different classes. Given a pair of data points (x′, y′), (x″, y″), the method augments the training data using interpolations given by (λx′+(1−λ)x″,λy′+(1−λ)y″), where λ˜Uniform([0,1]). The approach was later extended so that the smoothness property is further imposed in high-level learned representations. Moreover, mixup is used to enforce fairness constraints by forcing training algorithms to give preference to predictors that behave smoothly in the space in between sub-populations of the data.

In some embodiments, the system 100 is configured to generate data points for training a neural network 100, where data-data and noise-data pairs are mixed to define points where Ω can be estimated. Algorithm 1 below describes a procedure used to compute the proposed Ωₘᵢₓᵤₚ.

Algorithm 1 Procedure to compute Ωₘᵢₓᵤₚ.

```
Input mini-batch X_{[N×d]}, model h, monotonic dimensions M
X_{Ω}{ } # Initialize set of points used to compute regularizer.
\ddot{X}_{[N×d]}~Uniform(χ ^{N}) # Sample random mini-batch with size N.
\hat{X} = concat(X, \tilde{X}) # Concatenate data and random batches.
repeat
  i,j~Uniform({1, 2, . . . ,2N}²) # Sample random pair of points.
  λ~ Uniform([0, 1])
  x = λ\hat{X} ⁱ + (1− λ)\hat{X} ^{j} # Mix random pair.
  X_{Ω} add(x) # Add x to set of regularization points.
until Maximum number of pairs reached
${Ω}_{mixup} ( h , M ) = \frac{1}{\vert {X}_{Ω} \vert} {\sum }_{x ∈ {X}_{Ω}} {\sum }_{i ∈ M} max {( 0 \text{?} - \frac{\partial h ( x )}{\partial {x}_{i}} )}^{2}$
return Ωₘᵢₓᵤₚ
$\text{?} \text{indicates text missing or illegible when filed}$
```

Technical benefits of computing Ωₘᵢₓᵤₚ based on mixing data-data and noise-data pairs to define points where Ωₘᵢₓᵤₚ can be estimated include: (1) interpolation of data points more densely populates the convex hull of the training data; and (2) extrapolation cases where mixup is performed between data points and instances obtained at random results in points that lie anywhere between the data manifold and the boundaries of the space.

In some embodiments, the system 100 is configured to generate data points for training a neural network 100, where the monotonicity penalty Ω can be computed using one or more of interpolation and extrapolation.

Interpolation is performed by mixing-up pairs of data instances (i.e. when 0<λ<1). This encourages densely populating the convex hull of the training data which helps achieve monotonicity in the entirety of the hull rather than only on the training data itself.

Extrapolation is performed by mixing up data points with boundary instances obtained at random from Uniform(χ). Such combinations between data and random draws can lie anywhere between the data manifold and the boundaries of the space. This encourages monotonicity for points that are outside the hull made of the training sample. Performing mixup enables the computation of monotonicity penalty Ω on parts of the space that are disregarded if one focus only on either observed data or random draws from uninformed choices of distributions such as the uniform distributions.

Next, an empirical evaluation is carried out, during which the predictors resulting from different choices for computing Ω are evaluated during training. It can be observed that combining random and data points, by the system 100, yields monotonicity in a larger volume of χ compared to existing algorithms.

### Evaluation

In order to evaluate the effect of different choices of monotonicity penalties Ω, an empirical study using 3 datasets has been carried out, covering classification and regression settings with input spaces of different dimensions. Namely, results for the following datasets are reported: Compas, Loan Lending Club, and Blog Feedback. In Table 1, details on the three datasets used to evaluate an example system for training the neural network are listed. Models are implemented with a neural network using dense layers and weights are kept separate in early layers for the input dimensions with respect to which the model is expected to be monotonic. The depth of all networks is set to 3, and a bottleneck of size 10 for two datasets (Compas and Loan Lending Club), and 100 for the case of the Blog Feedback dataset. Training is carried out with Adam optimizer with a global learning rate of 5e-3, and y is set to 1e4. The training batch size is set to 256 throughout experiments.

TABLE 1
Description of datasets used for empirical evaluation

| Dataset | Dim[χ] | [M] | # Train | # Test | Task |
|---|---|---|---|---|---|
| Compas² | 13 | 4 | 4937 | 1235 | Classification |
| Loan Lending Club³ | 33 | 11 | 8500 | 1500 | Regression |
| Blog Feedback⁴ | 280 | 8 | 47287 | 6904 | Regression |

For each evaluation case, the baseline results are shown where training is carried out without any monotonicity-enforcing penalty. For the regularized cases with a monotonicity penalty Ω, the different approaches used for computing Ω are as follows:

1. Ω_{random}: uses random points drawn from Uniform(χ). In this case, the sample observed at each training iteration is set to a size of 1024 throughout all experiments.

2. Ωₜᵣₐᵢₙ: uses the actual data observed at each training iteration; i.e., the observed mini-batch itself is used to compute Ω.

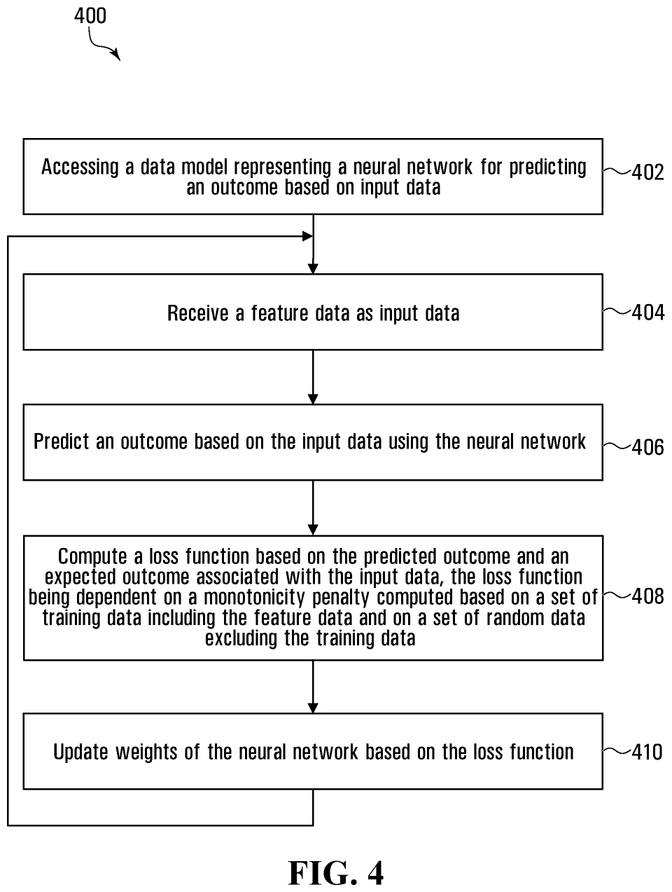

3. Ω_{mixup-TR} (e.g., as implemente by system 100 in the process described above or in FIG. 4): in this case, the penalty is computed on points generated by mixing-up points from the training data and random points. For example, for each mini-batch of size N>1, the batch of training data is augmented with complementary random data, and a final mini-batch of size 2N may be obtained. Out of the

$$\frac{2 N ( 2 N - 1 )}{2}$$

possible pairs or points from the final mini-batch of size 2N, a random subsample of 1024 pairs are taken to compute mixtures of instances. In this case, λ˜Uniform([0,1]) and A is independently drawn for each pair of points.

4. Ω_{mixup-TT} (for comparison purposes only): this approach is similar to Ω_{mixup-TR}, but mixup points are generated from pairings of training data only and combinations between data and random points are not allowed. Moreover, in order to enforce monotonicity in a volume of χ that is larger than the convex hull defined by the training sample, mixup of training data points using extrapolation is done via setting λ˜Uniform([−1,2]).

Results are summarized in Tables 2, 3, and 4 below, in terms of both prediction performance along with the metric indicating degree of monotonicity of the predictor for each regularization strategy. Prediction performance is measured in terms of accuracy for classification tasks, and RMSE for the case of regression. Monotonicity, on the other hand, assessed via the probability ρ of a model to not satisfy definition 1, is quantified via the fraction \hat{ρ} of points within a sample where the monotonicity constraint is violated; i.e., given a set of N data points, \hat{ρ} can be computed based on:

$$\hat{ρ} = \frac{{\sum }_{k = 1}^{N} 1 [ {min}_{i ∈ M} \frac{\partial h ( x )}{\partial {x}_{i}^{k}} < 0 ]}{N} , \qquad ( 3 )$$

such that \hat{ρ}=0 corresponds to monotonic models over the considered points. In order to quantify the degree of monotonicity in different parts of the space, p\hat{ } for 3 different sets of points are computed as:
\hat{ρ}_{random}, computed on a sample drawn according to Uniform(χ). A sample of 10,000 points are used throughout the experiments;
\hat{ρ}ₜᵣₐᵢₙ, computed on the training data; and
\hat{ρ}ₜₑₛₜ: computed on the test data.

Results reported in the tables correspond to 95% confidence intervals corresponding to multiple independent training runs.

TABLE 2
Evaluation results for the COMPAS dataset in terms of 95% confidence
intervals resulting from 20 independent training runs.

| | Non-mon. | Ω_{random} | Ωₜᵣₐᵢₙ | Ω_{Mixup-TT} | Ω_{Mixup-TR} |
|---|---|---|---|---|---|
| Validation acc. | 69.1% ± 0.2% | 68.5% ± 0.1% | 68.5% ± 0.1% | 68.5% ± 0.1% | 68.4% ± 0.1% |
| Test acc. | 68.5% ± 0.2% | 68.1% ± 0.2% | 68.0% ± 0.2% | 68.4% ± 0.2% | 68.3% ± 0.2% |
| ρ_{random} | 55.45% ± 12.26% | 0.01% ± 0.01% | 6.41% ± 4.54% | 2.50% ± 4.52% | 0.00% ± 0.00% |
| ρₜᵣₐᵢₙ | 92.98% ± 2.70% | 2.08% ± 2.21% | 0.00% ± 0.00% | 0.00% ± 0.00% | 0.00% ± 0.00% |
| ρₜₑₛₜ | 92.84% ± 2.75% | 2.16% ± 2.35% | 0.00% ± 0.00% | 0.00% ± 0.00% | 0.00% ± 0.00% |

Table 2 shows that results correspond to the checkpoint that obtained the best prediction performance on validation data throughout training. The lower the values of ρ, the better.

By comparing the prediction performances of the models obtained under the different regularization strategies with the unregularized baseline, it can be observed that across all datasets, the different penalties do not result in significant variations in the performance of the final predictors. This indicates that the class of predictors corresponding to the subset of [symbol] that is monotonic relative to M, denoted [symbol] _{M}, has enough capacity so as to be able to match the performance of the best canditates within [symbol] .

In terms of monotonicity, it is observed a clear pattern leading to the following intuition: monotonicity is achieved in the regions where it is enforced. This is evidenced by the observation that \hat{ρ}_{random} is consistently lower for Ω_{random} relative to Ωₜᵣₐᵢₙ and Ωₘᵢₓᵤₚ while, on the other hand, \hat{ρ}ₜᵣₐᵢₙ and \hat{ρ}ₜₑₛₜ are consistently lower for Ωₜᵣₐᵢₙ and Ωₘᵢₓᵤₚ compared to Ω_{random}. A comparison between Ωₜᵣₐᵢₙ and Ωₘᵢₓᵤₚ shows that enforcing monotonicity in points resulting from mixup yields predictors that are as monotonic as those given by the use of Ωₜᵣₐᵢₙ in actual data, but significantly better at the boundaries of χ. Finally, the results demonstrate that Ωₘᵢₓᵤₚ or Ω_{mixup-TR} achieves the best results in terms of monotonicity for all the sets of points considered. Moreover, this approach introduces no significant computation overhead.

TABLE 3-1
Evaluation results for the Loan Lending Club dataset in terms of 95%
confidence intervals resulting from 20 independent training runs.

| | Non-mon. | Ω_{random} | Ωₜᵣₐᵢₙ | Ω_{Mixup-TT} | Ω_{Mixup-TR} |
|---|---|---|---|---|---|
| Validation RMSE | 0.213 ± 0.000 | 0.223 ± 0.002 | 0.222 ± 0.002 | 0.227 ± 0.001 | 0.235 ± 0.001 |
| Test RMSE | 0.221 ± 0.001 | 0.230 ± 0.001 | 0.229 ± 0.002 | 0.232 ± 0.001 | 0.228 ± 0.001 |
| ρ_{random} | 99.11% ± 1.70% | 0.00% ± 0.00% | 14.47% ± 7.55% | 1.21% ± 1.19% | 0.00% ± 0.00% |
| ρₜᵣₐᵢₙ | 100.00% ± 0.00% | 7.23% ± 7.76% | 0.01% ± 0.01% | 0.00% ± 0.00% | 0.00% ± 0.00% |
| ρₜₑₛₜ | 100.00% ± 0.00% | 6.94% ± 7.43% | 0.04% ± 0.03% | 0.00% ± 0.01% | 0.00% ± 0.00% |

TABLE 3-2

| | | | |
|---|---|---|---|
| Non-mon. | Ω_{random} | Ωₜᵣₐᵢₙ | Ωₘᵢₓᵤₚ |

COMPAS

| | | | | |
|---|---|---|---|---|
| Validation accuracy | 69.1% ± 0.2% | 68.5% ± 0.1% | 68.5% ± 0.1% | 68.4% ± 0.1% |
| Test accuracy | 68.5% ± 0.2% | 68.1% ± 0.2% | 68.0% ± 0.2% | 68.3% ± 0.2% |
| \hat{ρ}_{random} | 55.45% ± 12.26% | 0.01% ± 0.01% | 6.41% ± 4.54% | 0.00% ± 0.00% |
| \hat{ρ}ₜᵣₐᵢₙ | 92.98% ± 2.70% | 2.08% ± 2.21% | 0.00% ± 0.00% | 0.00% ± 0.00% |
| \hat{ρ}ₜₑₛₜ | 92.84% ± 2.75% | 2.16% ± 2.35% | 0.00% ± 0.00% | 0.00% ± 0.00% |

Loan Lending Club

| | | | | |
|---|---|---|---|---|
| Validation RMSE | 0.213 ± 0.000 | 0.223 ± 0.002 | 0.222 ± 0.002 | 0.235 ± 0.001 |
| Test RMSE | 0.221 ± 0.001 | 0.230 ± 0.001 | 0.229 ± 0.002 | 0.228 ± 0.001 |
| \hat{ρ}_{random} | 99.11% ± 1.70% | 0.00% ± 0.00% | 14.47% ± 7.55% | 0.00% ± 0.00% |
| \hat{ρ}ₜᵣₐᵢₙ | 100.00% ± 0.00% | 7.23% ± 7.76% | 0.01% ± 0.01% | 0.00% ± 0.00% |
| \hat{ρ}ₜₑₛₜ | 100.00% ± 0.00% | 6.94% ± 7.43% | 0.04% ± 0.03% | 0.00% ± 0.00% |

Blog feedback

| | | | | |
|---|---|---|---|---|
| Validation RMSE | 0.174 ± 0.000 | 0.175 ± 0.001 | 0.177 ± 0.000 | 0.168 ± 0.000 |
| Test RMSE | 0.139 ± 0.001 | 0.139 ± 0.001 | 0.142 ± 0.001 | 0.143 ± 0.001 |
| \hat{ρ}_{random} | 76.17% ± 12.37% | 0.05% ± 0.08% | 3.86% ± 4.19% | 0.00% ± 0.01% |
| \hat{ρ}ₜᵣₐᵢₙ | 78.67% ± 5.28% | 78.59% ± 6.37% | 0.01% ± 0.01% | 0.01% ± 0.01% |
| \hat{ρ}ₜₑₛₜ | 76.29% ± 6.47% | 78.99% ± 7.20% | 0.02% ± 0.02% | 0.02% ± 0.02% |

Table 3-1 shows that results correspond to the checkpoint that obtained the best prediction performance on validation data throughout training. The lower the values of ρ the better.

Table 3-2 above shows evaluation results in terms of 95% confidence intervals resulting from 20 independent training runs. Results correspond to the checkpoint that obtained the best prediction performance on validation data throughout training. The lower the values of \hat{ρ} the better.

TABLE 4
Evaluation results for the Blog Feedback dataset in terms of 95%
confidence intervals resulting from 20 independent training runs.

| | Non-mon. | Ω_{random} | Ωₜᵣₐᵢₙ | Ω_{Mixup-TT} | Ω_{Mixup-TR} |
|---|---|---|---|---|---|
| Validation RMSE | 0.174 ± 0.000 | 0.175 ± 0.001 | 0.177 ± 0.000 | 0.178 ± 0.000 | 0.168 ± 0.000 |
| Test RMSE | 0.139 ± 0.001 | 0.139 ± 0.001 | 0.142 ± 0.001 | 0.143 ± 0.001 | 0.143 ± 0.001 |
| ρ_{random} | 76.17% ± 12.37% | 0.05% ± 0.08% | 3.86% ± 4.19% | 5.03% ± 5.27% | 0.00% ± 0.01% |
| ρₜᵣₐᵢₙ | 78.67% ± 5.28% | 78.59% ± 6.37% | 0.01% ± 0.01% | 0.01% ± 0.01% | 0.01% ± 0.01% |
| ρₜₑₛₜ | 76.29% ± 6.47% | 78.99% ± 7.20% | 0.02% ± 0.02% | 0.01% ± 0.01% | 0.02% ± 0.02% |

Table 4 shows that results correspond to the checkpoint that obtained the best prediction performance on validation data throughout training. The lower the values of ρ the better.

In this disclosure, monotonicity enforcing properties are implemented by the system 100 to ensure that outputs of a neural network model are expected to be monotonic with respect to some subset of the input space dimensions. Specifically, the system 100 may be implemented for general classes of models, where the learning scheme is expected to yield risk minimizers satisfying monotonicity requirements. It is shown that point-wise regularization penalties that bias the learning algorithm towards predictors that have non-negative gradients relative to the dimensions with respect to which monotonicity is desired.

The empirical evaluation shows that the monotonicity property is achieved in the parts of the space where it is imposed. Such finding suggests that past approaches will only enforce monotonicity too far from the data or too close to the data. In order to alleviate this issue, the disclosed systems and methods compute the regularization penalty (e.g., the monotonicity penalty) on mixup of training data points and random data points. The disclosed systems and methods are configured to generate the penalty data via linear combinations between training instances and random points. This way, the data points can be interpolated and populate the convex hull of the training sample. At the same time, additional data points can be extrapolated further away from the manifold where data lies. Empirical evaluation confirmed that the disclosed approach denoted by Ω_{mixup-TR}, using combinations between random samples and data instances, results in the most effective regularization strategy across all evaluated schemes.

Given that point-wise gradient penalties are effective in yielding monotonicity, this system can be used for larger neural networks applied in structured data such as image and text. In that case, however, monotonicity might be enforced between model's outputs and high-level representations so as to enable interpretability of predictions.

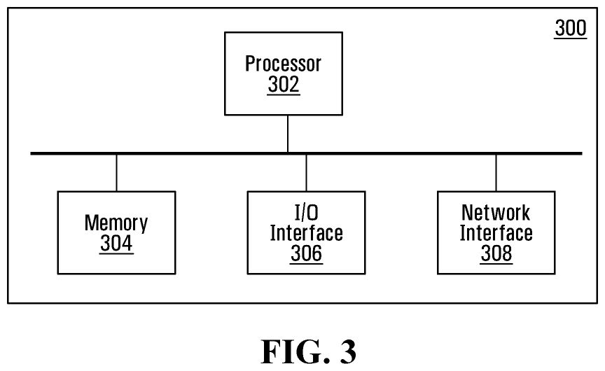

FIG. 3 is a schematic diagram of another example computing device 300 that implements a system (e.g., the training engine 112 on platform 100) for training an a neural network 110, in accordance with an embodiment. As depicted, computing device 300 includes one or more processors 302, memory 304, one or more I/O interfaces 306, and, optionally, one or more network interfaces 308.

Each processor 302 may be, for example, any type of general-purpose microprocessor or microcontroller, a digital signal processing (DSP) processor, an integrated circuit, a field programmable gate array (FPGA), a reconfigurable processor, a programmable read-only memory (PROM), or any combination thereof.

Memory 304 may include a suitable combination of any type of computer memory that is located either internally or externally such as, for example, random-access memory (RAM), read-only memory (ROM), compact disc read-only memory (CDROM), electro-optical memory, magneto-optical memory, erasable programmable read-only memory (EPROM), and electrically-erasable programmable read-only memory (EEPROM), Ferroelectric RAM (FRAM) or the like. Memory 304 may store code executable at processor 302, which causes training system to function in manners disclosed herein. Memory 304 includes a data storage. In some embodiments, the data storage includes a secure datastore. In some embodiments, the data storage stores received data sets, such as textual data, image data, or other types of data.

Each I/O interface 306 enables computing device 300 to interconnect with one or more input devices, such as a keyboard, mouse, camera, touch screen and a microphone, or with one or more output devices such as a display screen and a speaker.

Each network interface 308 enables computing device 300 to communicate with other components, to exchange data with other components, to access and connect to network resources, to serve applications, and perform other computing applications by connecting to a network such as network (or multiple networks) capable of carrying data including the Internet, Ethernet, plain old telephone service (POTS) line, public switch telephone network (PSTN), integrated services digital network (ISDN), digital subscriber line (DSL), coaxial cable, fiber optics, satellite, mobile, wireless (e.g. Wi-Fi, WiMAX), SS7 signaling network, fixed line, local area network, wide area network, and others, including any combination of these.

The methods disclosed herein may be implemented using a system that includes multiple computing devices 300. The computing devices 300 may be the same or different types of devices.

Each computing devices may be connected in various ways including directly coupled, indirectly coupled via a network, and distributed over a wide geographic area and connected via a network (which may be referred to as “cloud computing”).

For example, and without limitation, each computing device 300 may be a server, network appliance, set-top box, embedded device, computer expansion module, personal computer, laptop, personal data assistant, cellular telephone, smartphone device, UMPC tablets, video display terminal, gaming console, electronic reading device, and wireless hypermedia device or any other computing device capable of being configured to carry out the methods described herein.

FIG. 4 shows an example process performed by the system 100 in FIG. 1 (or the system 300 in FIG. 3), in accordance with an embodiment. At operation 402, the system 100 may access a data model representing a neural network 110 for predicting an outcome based on input data. The data model may be stored in data memory 120, for example. The data model may have weights that are updated with each epoch or training cycle.

At operation 404, the system 100 may, through a communication interface, receive a feature data as input data. Each feature data may correspond to an expected outcome or expected data that may be used downstream to calculate a loss function.

At operation 406, the system 100 may predict an outcome based on the input data using the neural network 110, using the weights of the neural network.

At operation 408, the system 100 may compute a loss function based on the predicted outcome and an expected outcome associated with the input data, the loss function being dependent on a monotonicity penalty computed based on a set of training data including the feature data and on a set of random data. The set of random data may exclude the training data.

In some embodiments, given the standard supervised learning setting where [symbol] : [symbol] ² [symbol] ⁺ is a loss function indicating the goodness of the predictions relative to ground truth targets, the goal of the training engine 112 is to find a predictor h∈ [symbol] such that its expected loss—or the so-called risk—over the input space is minimized. Such an approach yields the empirical risk minimization framework once a finite sample is used to estimate the risk. However, given the extra monotonicity requirement, the disclosed system 100 is configured to implement an augmented framework where such property is further enforced. For example, the training engine 112 is configured to seek the optimal monotonic predictors relative to M—denoted h*_{M}—such that:

$${h}_{M}^{*} ∈ {argmin}_{h ∈ ℋ} {𝔼}_{x , y ∼ 𝒳 \times 𝒴} [ ℓ ( h ( x ) , y ) ] + γ Ω ( h , M ) , \qquad ( 1 )$$

where γ is a hyperparameter weighing the importance of the monotonicity penalty Ω(h, M) which, in turn, is a measure of how monotonic the predictor h is relative to the dimensions indicated by M. The monotonicity penalty Ω(h, M) can be defined by the following gradient penalty:

$$Ω ( h , M ) = {𝔼}_{x ∼ 𝒟} [ {\sum }_{i ∈ M} max {( 0 , - \frac{\partial h ( x )}{\partial {x}_{i}} )}^{2} ] , \qquad ( 2 )$$

where

$$\frac{\partial h ( x )}{\partial {x}_{i}}$$

indicates the gradients of h relative to the input dimensions i∈M, which are constrained to be non-negative, rendering h monotonically non-decreasing relative to M.

In some embodiments, the monotonicity penalty Ω is determined based on interpolation of the training data and extrapolation of the training data and the random data.

In some embodiments, the monotonicity penalty Ω is determined based on at least one of: interpolation of the training data, extrapolation of the training data, interpolation of the training data and the random data, and extrapolation of the training data and the random data.

In some embodiments, interpolation of a pair of data points (x′, y′) from training data and (x″, y″) from the random data comprises generating new data points for training based on (λx′+(1−λ)x″, λy′+(1−λ)y″), and λ˜Uniform([0,1]). where x′ comprises feature data and y′ comprises the expected outcome.

In some embodiments, interpolation of the training data comprises mixing up data points from the training data.

In some embodiments, interpolation of a pair of data points (x′, y′), (x″, y″) from the training data comprises generating new data points for training based on (λx′+(1−λ)x″, λy′+(1−π)y″), and λ˜Uniform([0,1]).

In some embodiments, extrapolation of the training data and the random data comprises mixing up data points from the training data and the random data.

In some embodiments, extrapolation of the training data and the random data comprises generating new data points for training by, for each batch of training data with size N>1: augmenting the batch of training data with data points from the random data to obtain a new batch of mixed up training data of size 2N; and out of

$$\frac{2 N ( 2 N - 1 )}{2}$$

possible pairs of data points from the new batch of mixed up training data, selecting a random sample of k pairs of data points, wherein for each pair of data points (xm′, ym′), (xm″, ym″) from the k pairs: generating new data points for training based on (λxm′+(1−λ)xm″, λym′+(1−λ)ym″), wherein λ˜Uniform([0,1]), and λ is independently drawn.

In some embodiments, a monotonic predictor is represented by

$${h}_{M}^{*} ∈ arg {min}_{h ∈ ℋ} {𝔼}_{x \sim 𝒳} [ ( h ( x ) , y ) ] + γ Ω ( h , M ) ,$$

and Ω(h, M) is the monotonicity penalty configured to measure the monotonicity of the monotonic predictor h*_{M} relative to input dimensions indicated by M, M⊂{1, . . . d} being indicative of some subset of the input dimensions.

M⊂{1, . . . d} may include at least some of the monotonic feature data from the input data.

In some embodiments,

$$Ω ( h , M ) = {𝔼}_{x \sim 𝒟} [ {\sum }_{i ∈ M} {max ( 0 , - \frac{\partial h ( x )}{\partial {x}_{i}} )}^{2} ] , wherein \frac{\partial h ( x )}{\partial {x}_{i}}$$

indicates the gradients of h*_{M} relative to the input dimensions i∈M.

In some embodiments, [symbol] comprises data points generated by the interpolation of the training data and by the extrapolation of the training data and the random data.

At operation 410, the system 100 may update weights of the neural network 110 based on the loss function.

Steps 404 to 410 may be iteratively performed to fine tune the weights of the neural network 110 during the training process, until a predefined threshold has been reached. Such a predefined threshold may be, for example, a maximum number of epochs or training cycles. Another example may be a minimum value of the loss function.

### Applications of Monotonicity Penalties

In some embodiments, adding monotonicity constraints during training can yield extra benefits to trained models. In these cases, monotonicity is not a requirement, and hence it is not necessary for it to be satisfied everywhere. As such, the penalties discussed from now on are computed considering only data points, and no random draws are utilized. In the following, notions of monotonicity is enforced in selected neural network models, and advantages of using monotonicity for different applications such as controllable generative modelling and for the detection of anomalous data are disclosed.

### Disentangled Representation Learning Under Monotonicity

First consider the case of disentangled representation learning. In this case, generative approaches often assume that the latent variables are independent, and hence control over generative factors can be achieved. E.g., one can modify a specific aspect of the data by modifying the value of a specific latent variable. However, disentanglement is necessary but not sufficient to enable controllable data generation. That is, one needs latent variables that satisfy some notion of monotonicity to be able to decide their values resulting in desired properties.

For example, assume a user is interested in generating images of simple geometric forms, and desire to control factors such as shape and size. In this example, even if a disentangled set of latent variables is available, one cannot decide how to change the value of the latent variable to get a bigger or a smaller object if there is no monotonic relationship between the size and the value of the corresponding latent variable. This issue can be addressed by building upon a weakly supervised framework. This work extends the popular β-VAE setting by introducing weak supervision such that the training instances are presented to the model in pairs (x¹, x²) where only one or a few generative factors are changing between each pair.

Here, a notion of monotonocity is applied over the activations of the corresponding latent variables to have more controlable factors. In the VAE setting, data is assumed to be generated according to p(x|z)p(z) given the latent variables z. Approximation is then performed by introducing p_{θ}(x|z) and q_{ϕ}(z|x), both parameterized by neural networks. The goal is to have z fully factorizable in its dimensions, i.e.:

p(z)=Πᵢ₌₁^{Dim[z]}p(zᵢ),

which needs to be captured by the approximate posterior distribution q _{ϕ}(z|x). Training is performed by maximization of the following lower-bound on the data likelihood:

$${ℒ}_{ELBO} = {𝔼}_{{x}^{1} , {x}^{2}} {\sum }_{i ∈ \{ 1 , 2 \}} {𝔼}_{{\tilde{q}}_{ϕ} ( \hat{z} \vert {x}^{i} )} log ( {p}_{θ} ( {x}^{i} \vert \hat{z} ) ) - β {D}_{KL} ( {\tilde{q}}_{ϕ} ( \hat{z} \vert {x}^{i} ) , p ( \hat{z} ) ) , \qquad ( 4 )$$

where \tilde{q}_{ϕ}(\hat{z}ⱼ|xⁱ)=q_{ϕ}(zⱼ|xⁱ) for the latent dimensions zᵢ that change across x¹ and x², and \tilde{q}_{ϕ}(\hat{z}ⱼ|xⁱ)=½(q_{ϕ}(\hat{z}ⱼ|x¹)+q_{ϕ}(\hat{z}ⱼ|x²)) for those that are common (i.e., the approximate posterior of the shared latent variables are forced to be the same for x¹ and x²).

The outer expectation is estimated by sampling pairs of data instances (x¹, x²) where only a number of generative factors vary. In the experiments, the case where exactly one generative factor changes across inputs is considered. Moreover, the changing factor, denoted by y, is assigned to the dimension j of z such that:

y=arg max_{j∈Dim[z]}D_{KL}(zⱼ¹, zⱼ²).

While the above objective enforces disentanglement, controllable generation requires some regularity in z so that users can decide values of z resulting in desired properties in the generated samples.

To account for that, Ω_{VAE} can be introduced to enforce such a regularity. In this case, a monotonic relationship is enforced for the distance between data pairs where only a particular generative factor vary and a corresponding latent variable. In other words, an increasing trend in the value of each dimension of z should yield a greater change in the output along a generative factor. Formally, Ω_{VAE} is defined as the following symmetric cross-entropy estimate:

$${Ω}_{∀ AE} = - \frac{1}{2 m} {\sum }_{i = 1}^{m} log \frac{{e}^{\frac{L ( {x}^{4 , 1} {x}^{i , 2} {y}^{i} )}{μ}}}{{\sum }_{k = 1}^{K} {e}^{\frac{L ( {x}^{i , 1} , {x}^{i , 2} , k )}{μ}}} + log \frac{{e}^{\frac{L ( {x}^{i , 2} , {x}^{i , 1} , {y}^{i} )}{μ}}}{{\sum }_{k = 1}^{K} {e}^{\frac{L ( {x}^{i , 2} , {x}^{i , 1} , k )}{μ}}} , \qquad ( 5 )$$

where L is given by the gradient of the mean squared error (MSE) between images that are 1-factor away along the dimension y of z, assigned to the changing factor, i.e., for the pair xⁱ and x^{j} varying only across factor y, there is:

$$L ( {x}^{i} , {x}^{j} , y ) = \frac{\partial MSE ( {\hat{x}}^{i} , {x}^{j} )}{\partial {\tilde{z}}_{y}} . \qquad ( 6 )$$

In this case, \hat{x}ⁱ indicates the reconstruction of xⁱ. This approach is evaluated by training the same 4-layered convolutional VAEs using a 3D-shapes dataset. The dataset is composed of images containing shapes generated from 6 independent generative factors: floor color, wall color, object color, scale, shape and orientation. All combinations of these factors are present exactly once, resulting in m=480000. VAEs trained with and without the inclusion of the monotonicity penalty given by Ω_{VAE} are compared. The goal of the proposed framework is not to improve over current approaches in terms of how disentangled the learned representations are. Rather, the goal is to achieve similar results in that sense, but impose extra regularity and structure in the relationship between the generated images and the values of z so that the generative process is more easily controllable.

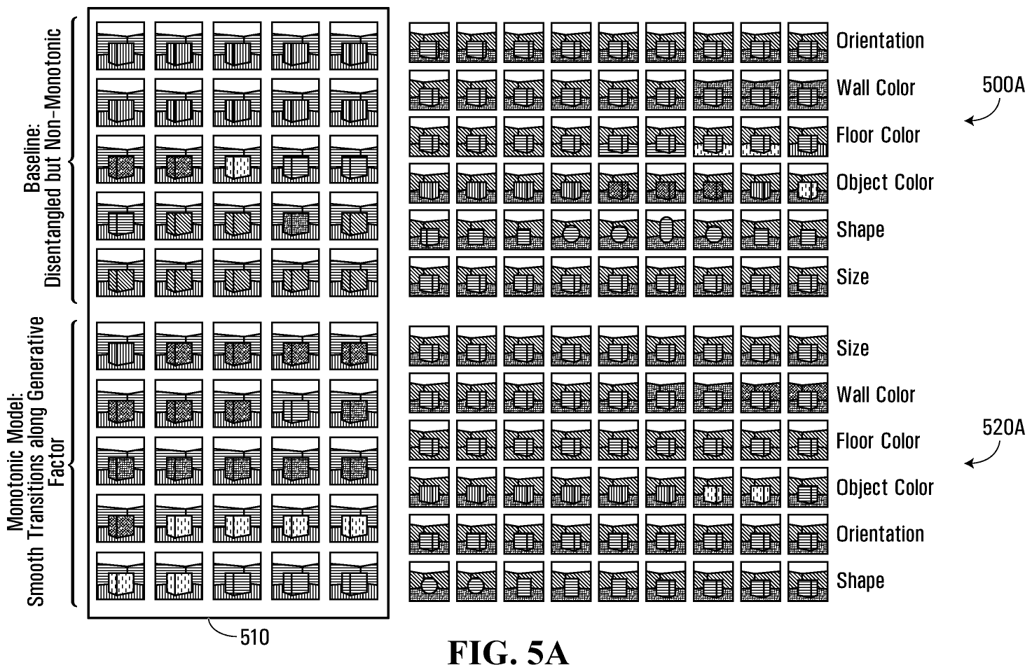

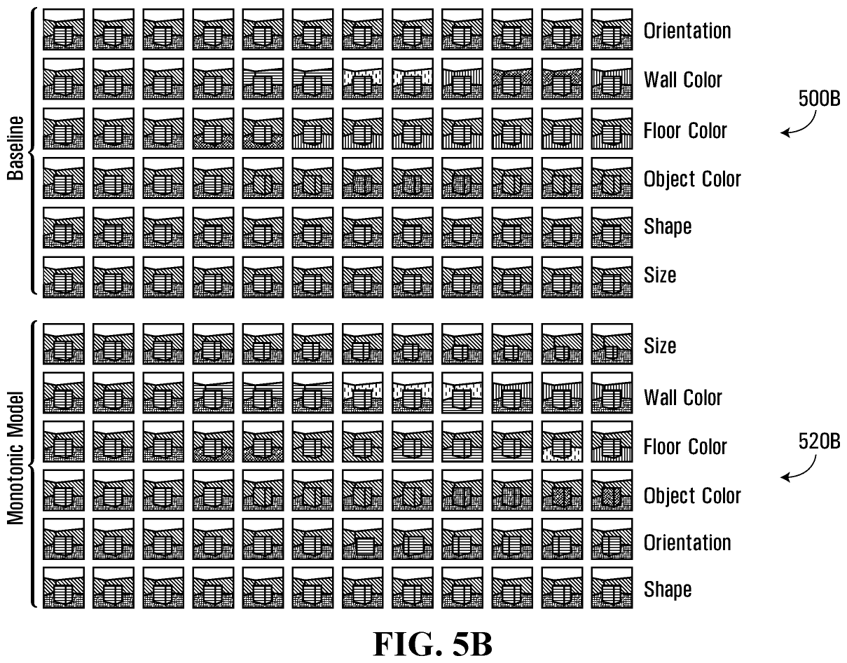

Qualitative analysis is performed and shown in FIGS. 5A and 5B, which show comparisons between data generated by standard and monotonic models. On the two panels in box 510 on the left of FIG. 5A, generations from a linear combination of the latent code of 2 images which only differs in the object color are compared. On the two panels vertically stacked on the right 500A, 520A, 500B, 520B, the same images are compared, but with one latent dimension changed at a time.

In FIG. 5A, The two panels in box 510 on the left represent the data generated by a linear combination of the latent code corresponding to two images that only vary in the factor object color. The panels 500A, 520A in FIG. 5A and 500B, 520B in FIG. 5B stacked on the right present a per-dimension traversal of the latent space starting from a common image. It can be observed that disentanglement is indeed achieved in both cases. The monotonic model presents much smoother transitions between colors while the base model gives long sequences of very close images followed by very sharp transitions where the colors sometimes repeat (e.g., green-yellow-green transitions in the fourth row).

As for the results per factor, the monotonic model provides more structure in the latent space compared to the base model. This can be observed in the shape factor. The monotonic model provides a certain order: sphere, cylinder, and then cube. Visually inspecting many samples, the monotonic model is following this order for the generated shapes. This pattern is even more pronounced in the color factors. It is found that the colors generated by the monotonic model follows the order of the colours in the HUE cycle. So the proposed model has ordered the latent space and one would know how to navigate it to generate a desired image. On the other hand, the baseline has no clear order of the latent space. For example, the baseline generates cubes at different ranges of z. Similarly, the colors generated by the baseline model do not have a clear order.

TABLE 5
top-1 accuracy of standard and group monotonic models.

| | | |
|---|---|---|
| Model | arg max_{kϵy} h(x)ₖ | arg max_{kϵy} Tₖ(x) |

CIFAR-10

| | | |
|---|---|---|
| WideResNet | 95.46% | 16.35% |
| MonoWideResNet | 95.64% | 94.95% |

ImageNet

| | | |
|---|---|---|
| ResNet-50 | 75.85% | 0.10% |
| MonoResNet-50 | 76.50% | 72.52% |

To further support the claim that Ω_{VAE} induces regularity in the latent space, analysis is shown in Table 5 above, by increasing z₃ (associated to floor color for both models), and recording the sequence of the generated colors. It is observed that for a large fraction of the data, the monotonic models yield sequences of images where the color of the floor is ordered according to its corresponding HUE angle.

### Group Monotonic Classifiers

Now consider the case of K-way classifiers realized through convolutional neural networks. In this case, data examples correspond to pairs x, y˜χ× [symbol] , and [symbol] ={1,2,3, . . . , K}, K∈ [symbol] . Models parameterize a data-conditional categorical distribution over [symbol] , i.e., for a given model h, h(x) [symbol] will yield likelihoods for each class indexed in [symbol] . Under this setting, the notion of Group Monotonicity is introduced: the aim is to find the models h such that the outputs corresponding to each class satisfy a monotonic relationship with a specific subset of high-level representations, given by some inner convolutional layer. Intuitively, the goal is to “reserve” groups of high-level features to activate more intensely than the remainder depending on the underlying class. Imposing such a structure can benefit the learned models via, for instance, more accurate anomaly detection.

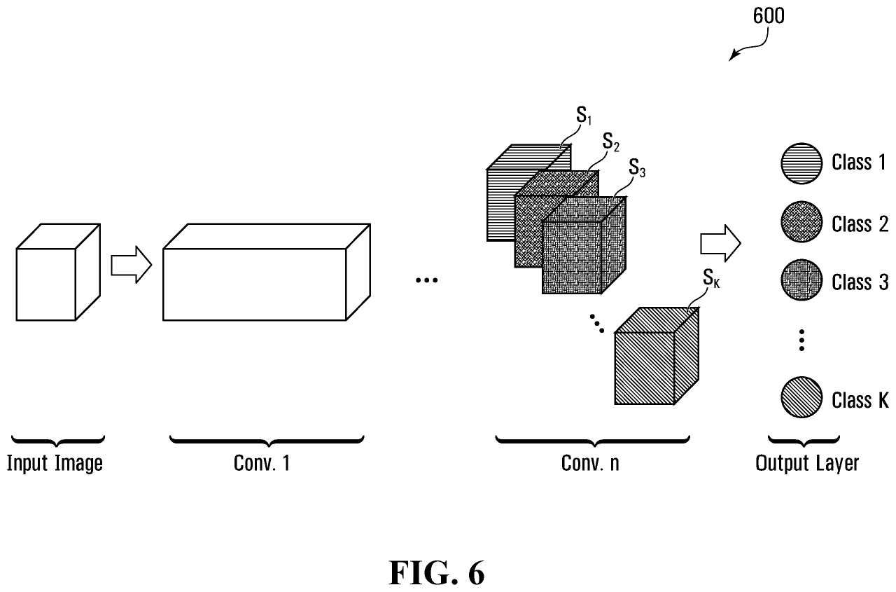

Let the outputs of a specific layer within a convolutional model be represented by a_{w}, w∈[1,2,3, . . . ,W], where W indicates the width of the chosen layer given by its number of output feature maps. For simplicity of exposition, consider the rather common case of convolutional layers where each feature map a_{w} is 2-dimensional. Then partition such a set of representations into disjoint subsets, or slices, of uniform sizes. Each subset is then paired with a particular output or class, and hence denoted by Sₖ, k∈ [symbol] . An illustration 600 is provided in FIG. 6, which shows a group monotonic convolutional model splitting representations into disjoint subsets, where a generic convolutional model has the outputs of a specific layer partitioned into slices Sₖ, which are then used to define output units over [symbol] .

Definition of group monotonic classifiers: let h be group monotonic for input x and class label y if h(x)_{y} is partially monotonic relative to all elements in S_{y}.

Intuitively, the goal is to “reserve” groups of high-level features to activate more intensely than the remainder depending on the underlying class. Imposing such a structure can benefit the learned models via, for instance, more accurate anomaly detection.

For training, monotonic risk minimization is performed as described in Eq. 1, and the risk is given by the negative log-likelihood over training points. Moreover, a penalty Ω is configured to focus only on observed data points during training and penalizes the slices of the Jacobian corresponding to a given class, i.e., a cross-entropy criterion enforces larger gradients on the specific class slice.

In order to formally introduce such a penalty, denoted by Ω_{group}, first define the total gradient Oₖ, k∈ [symbol] , of a slice Sₖ as follows:

$${O}_{y} ( x ) = {\sum }_{{a}_{w} ∈ {S}_{y}} {\sum }_{i , j} \frac{\partial {h ( x )}_{y}}{\partial {a}_{w , i , j}} ,$$

where the inner sum accounts for spatial dimensions of a_{w}. Given the set of total gradients, a batch of size m, and inverse temperature μ, Ω_{group} will be:

$${Ω}_{group} = - \frac{1}{m} {\sum }_{i = 1}^{m} log \frac{{e}^{\frac{{O}_{{y}^{i}}^{i} ( {x}^{i} )}{μ}}}{{\sum }_{k = 1}^{K} {e}^{\frac{{O}_{k}^{i} ( {x}^{i} )}{μ}}} . \qquad ( 7 )$$

### Assessing Performance of Group Monotonic Classifiers

The evaluation is started by verifying whether the group monotonicity property can be effectively enforced into classifiers trained on standard object recognition benchmarks. In order to do so, the performance of the total activation classifier is verified, as defined by: arg max _{k∈y}Tₖ(x), where Tₖ indicates the total activation on slice Sₖ: Tₖ(x)=Σₐ_{_{w}}_{∈s}_{ₖ}Σ_{i,j}a_{w,i,j}(x).

A good prediction performance of such a classifier serves as evidence that the group monotonicity property is satisfied by the model over the test data under consideration since it indicates the slice relative to the underlying class of test instances has the highest total activation. Evaluations are run for both CIFAR-10 and ImageNet, and classifiers in each case correspond to WideResNets and ResNet-50, respectively. Training details are presented below.

For the case of CIFAR-10, WideResNets are used. The models are initialized randomly and trained both with and without the monotonicity penalty. Standard stochastic gradient descent (SGD) implements the parameters update rule with a learning rate starting at 0.1, being decreased by a factor of 10 on epochs 10, 150, 250, and 350.

Training is carried out for a total of 600 epochs with a batch size of 64. For ImageNet, on the other, training consists of fine tuning a pre-trained ResNet-50, where the fine-tuning phase included the monotonicity penalty, this is done by training the model for 30 epochs on the full ImageNet training partition. In this case, given that the label set Y is relatively large, using the standard ResNet-50 would result in small slices Sₖ. To avoid that, an extra final convolution layer with W=15K. Training is once more carried out with SGD using a learning rate set to 0.001 in this case, and reduced by a factor of 5 at epoch 20. In both cases, the group monotonicity property is enforced at the last convolutional layer. Other hyperparameters such as the strength γ of the monotonicity penalty as well as the inverse temperature μ used to compute Ω_{group} are set to 1 and 50 for the case of CIFAR-10, and to 5 and 10 for the case of ImageNet. Both momentum and weight decay are further employed and their corresponding parameters are set to 0.9 and 0.0001. For MNIST classifiers, training is performed for 20 epochs using a batch size of 64 and the Adadelta optimizer with a learning rate of 1.

TABLE 6
Top-1 accuracy of standard and group monotonic models.

| | | |
|---|---|---|
| Model | arg max_{kϵy} h(x)ₖ | arg max_{kϵy} Tₖ(x) |

CIFAR-10

| | | |
|---|---|---|
| WideResNet | 95.46% | 16.35% |
| MonoWideResNet | 95.64% | 94.95% |

ImageNet

| | | |
|---|---|---|
| ResNet-50 | 75.85% | 0.10% |
| MonoResNet-50 | 76.50% | 72.52% |

Results are reported in Table 6 above in terms of the top-1 prediction accuracy measured on the test data. Standard classifiers are used as the baselines where no monotonicity penalty is applied in order to isolate the effect of the penalty. In both datasets, the total activation classifiers for group monotonic models (indicated by the prefix mono) are able to approximate the performance of the classifier defined at the output layer, arg max _{k∈y}h(x)ₖ. This suggests that the higher total activation generally matches the predicted class for group monotonic models, which indicates the property is successfully enforced.

Considering performances obtained at the output layer, there were small variations in accuracy when including monotonicity penalties, which should be considered in practical uses of group monotonicity. Nonetheless, results suggest that one can perform closely to unconstrained models while focusing on the set of group monotonic candidates.

TABLE 7

| | | |
|---|---|---|
| Model | arg max_{kϵy} h(x)ₖ | arg max_{kϵy} Tₖ(x) |

10%

| | | |
|---|---|---|
| WideResNet | 85.68% | 16.35% |
| MonoWideResNet | 85.77% | 82.21% |

30%

| | | |
|---|---|---|
| WideResNet | 92.12% | 14.51% |
| MonoWideResNet | 92.42% | 88.88% |

60%

| | | |
|---|---|---|
| WideResNet | 94.51% | 10.08% |
| MonoWideResNet | 94.86% | 93.81% |

Table 7 above shows top-1 accuracy obtained by both standard and group monotonic models on sub-samples of CIFAR-10. Predicition performance obtained by classifiers defined by the total activations is upper bounded by the performance obtained at the output layer for monotonic models.

Additional experiments are reported on Table 7 above for cases with small sample sizes, where the performance of the classifier defined at the output layer upper bounds that of the total activation classifier, i.e., the better the underlying classifier the more group monotonic it can be made.

### Using Group Monotonicity to Detect Anomalies

After showing that group monotonicity can be enforced successfully without significantly affecting the prediction performance, approaches to leverage it and applications of the models satisfying such a property are described next. In particular, consider the application of detecting anomalous data instances, i.e., those where the model may have made a mistake. For example, consider the case where a classifier is deployed to production and, due to some problem external to the model, it is queried to do prediction for an input consisting of white noise. Standard classifiers would provide a prediction even for such a clearly anomalous input. However, a more desirable behavior is to somehow indicate that the instance is problematic. Imposing structure in the features, e.g., by enforcing group monotonicity, can help in deciding when not to predict.

To evaluate the proposed method, anomalous test instances are implemented using adversarial perturbations. Namely, creating L_{∞} PGD attackers and detecting anomalies based on simple statistics of the features. For example, for a given input x, computing the normalized entropy H*(x) of the categorical distribution defined by the application of the softmax operator over the set of total activations T [symbol] (x):

$${H}^{*} ( x ) = \frac{{\sum }_{k ∈ 𝓎} {p}_{k} ( x ) log {p}_{k}}{log K} ,$$

where K=| [symbol] | and the set p [symbol] (x) corresponds to the parameters of a categorical distribution defined by:

p [symbol] (x)=softmax(T_{z,126} (x)).

Decisions can then be made by comparing H*(x) with a threshold τ∈[0,1], defining the detector 1_{{H*>τ}}.

The detection performance of this approach on both MNIST and CIFAR-10 is evaluated. Training for the case of CIFAR-10 follows the same setup discussed above. For MNIST on the other hand, the standard LeNet architecture is modified by increasing the width of the second convolutional layer from 64 to 150. This layer is then used to enforce the group monotonicity property. The resulting model is referred to as WideLeNet. Moreover, γ and μ are set to 1e10 and 1, respectively. Adversarial attacks are created under the white-box setting, i.e., by exposing the full model to the attacker. The perturbation budget in terms of L_{∞} distance is set to 0.3 and

$$\frac{8}{255}$$

for the cases of MNIST and CIFAR-10, respectively. Detection performance is reported in Table 8 for the considered cases in terms of the area under the operating curve (AUC-ROC).

TABLE 8
AUC-ROC (the higher the better) for the detection
of adversarially perturbed data instances.

| | |
|---|---|
| Model | AUC-ROC |

MNIST

| | |
|---|---|
| WideLeNet | 54.47% |
| MonoWideLeNet | 100.00% |

CIFAR-10

| | |
|---|---|
| WideResNet | 67.35% |
| MonoWideResNet | 79.33% |

The baselines are the models for which the monotonicity penalty is not enforced. They are trained under the same conditions and the same computation budget as the models where the penalty is enforced. The results are as expected, i.e., for monotonic models, test examples for which the total activations are not structured very often correspond to anomalous inputs.

### Selecting Feature Maps to Compute Visual Explanations

Approaches based on Class Activation Maps (CAM) such as Grad-CAM and its variations seek to extract explanations from convolutional models. By explanation it means referring to indications of properties of the data implying the predictions of a given model. Under such a framework, one can obtain so-called explanation heat-maps through the following steps: (1) computing a weighted sum of activations of feature maps in a chosen layer; (2) upscaling the results in order to match the dimensions of the input data; (3) superimposing results onto the input data.

Specifically for the case of applications to image data, following those steps results in highlighting the patches of the input that were deemed relevant to yield the observed predictions. Different approaches were then introduced in order to define the weights used in the first step.

A very common choice is to use the total gradient of the output corresponding to the prediction with respect to activations of each feature map. For the case of group monotonic classifiers, one can verify whether one can define useful explanation heat-maps by considering only the feature slices corresponding to the predicted class, i.e., for a given input pair (x; y), computing explanation heat-maps considering only its corresponding feature activation slice S [symbol] (x).

An experiment is designed to evaluate the effectiveness of such an approach by using external auxiliary classifiers to perform predictions from test data that was occluded using explanation heat-maps obtained using different models and sets of representations. In other words, the explanation maps can be used to remove from the data the parts that were not indicated as relevant. One can assume that good explanation maps will be such that classifiers are able to correctly classify occluded data since relevant patches are conserved. In further details, occlusions are computed by first applying a CAM operator given a model h and data x, which results in a heat-map with entries in [0; 1]. The heat-map is then used as a multiplicative mask to get an occluded version of x, denoted x′, i.e.:

x′=CAM(x, h)○x,

where the operator o indicates element-wise multiplication.

TABLE 9

| | Aux. classifier | | | |
|---|---|---|---|---|
| | ResNet- | MobileNet- | VGG- | |
| Model (h) | 50 | v3 | 16 | SqueezeNet |
| Reference perf. | 77.62% | 74.04% | 71.59% | 58.09% |
| ResNet-50 | 72.94% | 68.31% | 67.34% | 49.95% |
| MonoResNet-50 | 72.88% | 68.75% | 66.99% | 48.92% |
| MonoResNet-50 | 72.44% | 66.55% | 66.92% | 45.83% |
| (Constrained) | | | | |

Explanation maps are computed using the same neural network models discussed in Assessing performance of group monotonic classifiers for ImageNet. The CAM operator corresponds to a variation of Grad-CAM++ where the model activations are directly employed for weighing feature maps rather than the gradients. Four auxiliary pre-trained classifiers corresponding to ResNext-50, MobileNet-v3, VGG-16 and SqueezeNet are considered. Results are reported in Table 9 which also include the reference performance of the auxiliary classifiers on the standard validation set in order to provide an idea of the gap in performance resulting from removing parts of test images via occlusion. The performance reported is highlighted in the last row of the Table. In that case, explanation maps for the group monotonic model are computed from only the features of the class slice, which is enough to match the performance of a standard ResNet-50 with full access to the features. This suggests that representations learned by group monotonic models are such that all the information required to explain a given class is contained in the slice reserved for that class.

Embodiments performing the operations for anomaly detection and anomaly scoring provide certain advantages over manually assessing anomalies. For example, in some embodiments, all data points are assessed, which eliminates subjectivity involved in judgement-based sampling, and may provide more statistically significant results than random sampling. Further, the outputs produced by embodiments of system are reproducible and explainable.

The embodiments of the devices, systems and methods described herein may be implemented in a combination of both hardware and software. These embodiments may be implemented on programmable computers, each computer including at least one processor, a data storage system (including volatile memory or non-volatile memory or other data storage elements or a combination thereof), and at least one communication interface.

Program code is applied to input data to perform the functions described herein and to generate output information. The output information is applied to one or more output devices. In some embodiments, the communication interface may be a network communication interface. In embodiments in which elements may be combined, the communication interface may be a software communication interface, such as those for inter-process communication. In still other embodiments, there may be a combination of communication interfaces implemented as hardware, software, and combination thereof.

Throughout the foregoing discussion, numerous references will be made regarding servers, services, interfaces, portals, platforms, or other systems formed from computing devices. It should be appreciated that the use of such terms is deemed to represent one or more computing devices having at least one processor configured to execute software instructions stored on a computer readable tangible, non-transitory medium. For example, a server can include one or more computers operating as a web server, database server, or other type of computer server in a manner to fulfill described roles, responsibilities, or functions.

The foregoing discussion provides many example embodiments. Although each embodiment represents a single combination of inventive elements, other examples may include all possible combinations of the disclosed elements. Thus if one embodiment comprises elements A, B, and C, and a second embodiment comprises elements B and D, other remaining combinations of A, B, C, or D, may also be used.

The term “connected” or “coupled to” may include both direct coupling (in which two elements that are coupled to each other contact each other) and indirect coupling (in which at least one additional element is located between the two elements).

The technical solution of embodiments may be in the form of a software product. The software product may be stored in a non-volatile or non-transitory storage medium, which can be a compact disk read-only memory (CD-ROM), a USB flash disk, or a removable hard disk. The software product includes a number of instructions that enable a computer device (personal computer, server, or network device) to execute the methods provided by the embodiments.

The embodiments described herein are implemented by physical computer hardware, including computing devices, servers, receivers, transmitters, processors, memory, displays, and networks. The embodiments described herein provide useful physical machines and particularly configured computer hardware arrangements. The embodiments described herein are directed to electronic machines and methods implemented by electronic machines adapted for processing and transforming electromagnetic signals which represent various types of information. The embodiments described herein pervasively and integrally relate to machines, and their uses; and the embodiments described herein have no meaning or practical applicability outside their use with computer hardware, machines, and various hardware components. Substituting the physical hardware particularly configured to implement various acts for non-physical hardware, using mental steps for example, may substantially affect the way the embodiments work. Such computer hardware limitations are clearly essential elements of the embodiments described herein, and they cannot be omitted or substituted for mental means without having a material effect on the operation and structure of the embodiments described herein. The computer hardware is essential to implement the various embodiments described herein and is not merely used to perform steps expeditiously and in an efficient manner.

The embodiments and examples described herein are illustrative and non-limiting. Practical implementation of the features may incorporate a combination of some or all of the aspects, and features described herein should not be taken as indications of future or existing product plans. Applicant partakes in both foundational and applied research, and in some cases, the features described are developed on an exploratory basis.

Although the embodiments have been described in detail, it should be understood that various changes, substitutions and alterations can be made herein without departing from the scope as defined by the appended claims.

Moreover, the scope of the present application is not intended to be limited to the particular embodiments of the process, machine, manufacture, composition of matter, means, methods and steps described in the specification. As one of ordinary skill in the art will readily appreciate from the disclosure of the present invention, processes, machines, manufacture, compositions of matter, means, methods, or steps, presently existing or later to be developed, that perform substantially the same function or achieve substantially the same result as the corresponding embodiments described herein may be utilized. Accordingly, the appended claims are intended to include within their scope such processes, machines, manufacture, compositions of matter, means, methods, or steps.

### REFERENCES

[1] Archer, Norman P and Wang, Shouhong. Application of the back propagation neural network algorithm with monotonicity constraints for two-group classification problems. Decision Sciences, 24(1):60-75, 1993.
[2] Bandanau, Dzmitry and Cho, Kyunghyun and Bengio, Yoshua. Neural machine translation by jointly learning to align and translate. arXiv preprint arXiv:1409.0473, 2014.
[3] William Taylor Bakst and Nobuyuki Morioka and Erez Louidor. Monotonic Kronecker-Factored Lattice. International Conference on Learning Representations, 2021.
[4] Ching-Yao Chuang and Youssef Mroueh. Fair Mixup: Fairness via Interpolation. International Conference on Learning Representations, 2021.
[5] Dugas, Charles and Bengio, Yoshua and Bélisle, François and Nadeau, Claude and Garcia, René. Incorporating second-order functional knowledge for better option pricing. Advances in neural information processing systems, :472-478, 2001.
[6] Fefferman, Charles and Mitter, Sanjoy and Narayanan, Hariharan. Testing the manifold hypothesis. Journal of the American Mathematical Society, 29(4):983-1049, 2016.
[7] Garcia, Eric and Gupta, Maya. Lattice Regression. In Y. Bengio and D. Schuurmans and J. Lafferty and C. Williams and A. Culotta, editors, Advances in Neural Information Processing Systems, 2009. Curran Associates, Inc.
[8] Goodfellow, Ian J and Shlens, Jonathon and Szegedy, Christian. Explaining and harnessing adversarial examples. arXiv preprint arXiv:1412.6572, 2014.
[9] Graves, Alex and Jaitly, Navdeep. Towards end-to-end speech recognition with recurrent neural networks. International conference on machine learning, pages 1764-1772,2014. PMLR.
[10] Gupta, Akhil and Shukla, Naman and Marla, Lavanya and Kolbeinsson, Arinbjörn and Yellepeddi, Kartik. How to Incorporate Monotonicity in Deep Networks While Preserving Flexibility?. arXiv preprint arXiv:1909.10662, 2019.
[11] Kingma, Diederik P and Ba, Jimmy. Adam: A method for stochastic optimization. arXiv preprint arXiv:1412.6980, 2014.
[12] Krizhevsky, Alex and Sutskever, Ilya and Hinton, Geoffrey E. Imagenet classification with deep convolutional neural networks. Advances in neural information processing systems, 25:1097-1105, 2012.
[13] Liu, Xingchao and Han, Xing and Zhang, Na and Liu, Qiang. Certified Monotonic Neural Networks. In H. Larochelle and M. Ranzato and R. Hadsell and M. F. Balcan and H. Lin, editors, Advances in Neural Information Processing Systems, pages 15427-15438,2020. Curran Associates, Inc.
[14] Nguyen, An-phi and Mart13̆052′fnez, Mar13̆053′fa Rodr13̆053′guez. Mononet: towards interpretable models by learning monotonic features. arXiv preprint arXiv:1909.13611, 2019.
[15] Sivaraman, Aishwarya and Farnadi, Golnoosh and Millstein, Todd and Van den Broeck, Guy. Counterexample-Guided Learning of Monotonic Neural Networks. In H. Larochelle and M. Ranzato and R. Hadsell and M. F. Balcan and H. Lin, editors, Advances in Neural Information Processing Systems, pages 11936-11948,2020. Curran Associates, Inc.
[16] Verma, Vikas and Lamb, Alex and Beckham, Christopher and Najafi, Amir and Mitliagkas, loannis and Lopez-Paz, David and Bengio, Yoshua. Manifold mixup: Better representations by interpolating hidden states. International Conference on Machine Learning, pages 6438-6447, 2019. PMLR.
[17] Wehenkel, Antoine and Louppe, Gilles. Unconstrained Monotonic Neural Networks. In H. Wallach and H. Larochelle and A. Beygelzimer and F. d Alché-Buc and E. Fox and R. Garnett, editors, Advances in Neural Information Processing Systems, 2019. Curran Associates, Inc.
[18] You, Seungil and Ding, David and Canini, Kevin and Pfeifer, Jan and Gupta, Maya. Deep lattice networks and partial monotonic functions. arXiv preprint arXiv:1709.06680, 2017.
[19] Hongyi Zhang and Moustapha CissÃ© and Yann N. Dauphin and David Lopez-Paz. mixup: Beyond Empirical Risk Minimization. ICLR (Poster), 2018.

1. A computer-implemented system for training a neural network with enforced monotonicity, the system comprising:
at least one processor; and
memory in communication with said at least one processor, wherein the memory stores instructions for providing a data model representing a neural network for predicting an outcome based on input data, the instructions when executed at said at least one processor causes said system to:
receive a feature data as input data, wherein the feature data comprises monotonic feature data;
predict an outcome based on the input data using the neural network;
compute a loss function based on the predicted outcome and an expected outcome associated with the input data, the loss function [symbol] being dependent on a monotonicity penalty Ω computed based on a set of training data including the feature data and on a set of random data; and
update weights of the neural network based on the loss function.

2. The system of claim 1, wherein the set of random data excludes the training data.

3. The system of claim 2, wherein the monotonicity penalty D. is determined based on at least one of: interpolation of the training data and extrapolation of the training data and the random data.

4. The system of claim 3, wherein interpolation of the training data comprises mixing up data points from the training data.

5. The system of claim 4, wherein interpolation of a pair of data points (x′, y′), (x″, y″) from the training data comprises generating new data points for training based on (λx′+(1−λ)x″, λy′+(1−λ)y″), and λ˜Uniform([0,1]).

6. The system of claim 3, wherein extrapolation of the training data and the random data comprises mixing up data points from the training data and the random data.

7. The system of claim 6, wherein extrapolation of the training data and the random data comprises generating new data points for training by, for each batch of training data with size N>1:
augmenting the batch of training data with data points from the random data to obtain a new batch of mixed up training data of size 2N; and
out of the
$$\frac{2 N ( 2 N - 1 )}{2}$$
possible pairs of data points from the new batch of mixed up training data, selecting a random sample of k pairs of data points, wherein for each pair of data points (xm′, ym′), (xm″, ym″) from the k pairs: generating new data points for training based on (λxm′+(1−λ)xm″, λym′+(1−λ)ym″), wherein λ˜Uniform([0,1]), and λ is independently drawn.

8. The system of claim 3, wherein monotonic predictor is represented by
$${h}_{M}^{*} ∈ arg {min}_{h ∈ ℋ} {𝔼}_{x \sim 𝒳} [ ( h ( x ) , y ) ] + γ Ω ( h , M ) ,$$
and Ω(h, M) is the monotonicity penalty configured to measure the monotonicity of the monotonic predictor h*_{M} relative to input dimensions indicated by M, M⊂{1, . . . d} being indicative of a subset of the input dimensions and comprising at least some of the monotonic feature data from the input data.

9. The system of claim 8, wherein
$$Ω ( h , M ) = {𝔼}_{x \sim 𝒟} [ {\sum }_{i ∈ M} {max ( 0 , - \frac{\partial h ( x )}{\partial {x}_{i}} )}^{2} ] , wherein \frac{\partial h ( x )}{\partial {x}_{i}}$$
indicates the gradients of h*_{M} relative to the input dimensions i∈M.

10. The system of claim 9, wherein [symbol] comprises data points generated by the interpolation of the training data and by the extrapolation of the training data and the random data.

11. The system of claim 1, wherein the feature data comprises non-monotonic feature data.

12. A computer-implemented method for training a neural network with enforced monotonicity, the method comprising:
accessing a data model representing a neural network for predicting an outcome based on input data;
receiving a feature data as input data, wherein the feature data comprises monotonic feature data;
predicting an outcome based on the input data using the neural network;
computing a loss function based on the predicted outcome and an expected outcome associated with the input data, the loss function [symbol] being dependent on a monotonicity penalty Ω computed based on a set of training data including the feature data and on a set of random data; and
updating weights of the neural network based on the loss function.

13. The method of claim 12, wherein the set of random data excludes the training data.

14. The method of claim 12, wherein the feature data comprises non-monotonic feature data.

15. The method of claim 14, wherein the monotonicity penalty D. is determined based on at least one of: interpolation of the training data or extrapolation of the training data and the random data.

16. The method of claim 15, wherein interpolation of the training data comprises mixing up data points from the training data.

17. The method of claim 16, wherein interpolation of a pair of data points (x′, y′), (x″, y″) from the training data comprises generating new data points for training based on (λx′+(1−λ)x″, λy′+(1−λ)y−), and λ˜Uniform([0,1]).

18. The method of claim 15, wherein extrapolation of the training data and the random data comprises mixing up data points from the training data and the random data.

19. The method of claim 18, wherein extrapolation of the training data and the random data comprises generating new data points for training by, for each batch of training data with size N>1:
augmenting the batch of training data with data points from the random data to obtain a new batch of mixed up training data of size 2N; and
out of the
$$\frac{2 N ( 2 N - 1 )}{2}$$
possible pairs of data points from the new batch of mixed up training data, selecting a random sample of k pairs of data points, wherein for each pair of data points (xm′, ym′), (xm″, ym″) from the k pairs: generating new data points for training based on (λxm′+(1−λ)xm″, λym′+(1−λ)ym″), wherein λ˜Uniform([0,1]), and λ is independently drawn.

20. The method of claim 15, wherein a monotonic predictor is represented by
$${h}_{M}^{*} ∈ arg {min}_{h ∈ ℋ} {𝔼}_{x \sim 𝒳} [ ( h ( x ) , y ) ] + γ Ω ( h , M ) ,$$
and Ω(h, M) is the monotonicity penalty configured to measure the monotonicity of the monotonic predictor h*_{M} relative to input dimensions indicated by M, M⊂{1, . . . d} being indicative of a subset of the input dimensions and comprising at least some of the monotonic feature data from the input data.
$$Ω ( h , M ) = {𝔼}_{x \sim 𝒟} [ {\sum }_{i ∈ M} {max ( 0 , - \frac{\partial h ( x )}{\partial {x}_{i}} )}^{2} ] , wherein \frac{\partial h ( x )}{\partial {x}_{i}}$$

21. The method of claim 20, wherein indicates the gradients of h*_{M} relative to the input dimensions i∈M.

22. The method of claim 21, wherein [symbol] comprises data points generated by the interpolation of the training data and by the extrapolation of the training data and the random data.

23. A non-transitory computer-readable storage medium storing a data model representing a neural network for predicting an outcome based on input data, wherein the neural network is trained by:
receiving a feature data as input data, wherein the feature data comprises monotonic feature data;
predicting an outcome based on the input data using the neural network;
computing a loss function based on the predicted outcome and an expected outcome associated with the input data, the loss function [symbol] being dependent on a monotonicity penalty D. computed based on a set of training data including the feature data and on a set of random data; and
updating weights of the neural network based on the loss function.
